(19) United States
(12) Patent Application Publication
(10) Pub. No.: US 2020/0186372 A1
(43) Pub. Date: Jun. 11, 2020

(54) Attendance Configuration Methods and Apparatuses

(71) Applicant: Dingtalk Holding (Cayman) Limited, Grand Cayman (KY)

(72) Inventors: Liying Yu, Zhejiang (CN); Yi Liu, Zhejiang (CN); Yi Zhang, Zhejiang (CN); Chenlu Guo, Zhejiang (CN)

(21) Appl. No.: 16/786,811

(22) Filed: Feb. 10, 2020

Related U.S. Application Data
(63) Continuation of application No. PCT/CN2018/098459, filed on Aug. 3, 2018.

(30) Foreign Application Priority Data
Aug. 11, 2017 (CN) 201710685461.0

(51) Int. Cl. H04L 12/18

(52) U.S. Cl. CPC H04L 12/1822; H04L 12/1831; H04L 12/1818

(57) ABSTRACT

Attendance configuration methods and apparatuses are provided. A method may include determining an attendance group related to a community, the attendance group including at least one community member of the community; and initiating an attendance group configuration request to a person in charge of the attendance group to set an attendance condition of the attendance group by the person in charge.

### CROSS REFERENCE TO RELATED PATENT APPLICATIONS

This application claims priority to and is a continuation of PCT Patent Application No. PCT/CN2018/098459 filed on 3 Aug. 2018, and is related to and claims priority to Chinese Application No. 201710685461.0, filed on 11 Aug. 2017 and entitled “Attendance Configuration Methods and Apparatuses,” which are incorporated herein by reference in their entirety.

### TECHNICAL FIELD

The present disclosure relates to the technical field of terminals, and particularly to attendance configuration methods and apparatuses.

### BACKGROUND

In related technologies, mobile group work platforms have become widely used in work processes of various groups such as enterprises, educational institutions, government agencies, etc. Such platforms not only improve the efficiency of communications between users and reduce the communication costs, but also effectively improve the event processing efficiency and the work efficiency of the users.

For example, a mobile group work platform can be configured with attendance functions. By setting attendance conditions for group members in a group in advance, a group member can run a client of the mobile group work platform to achieve a quick attendance operation under circumstances that attendance conditions are met.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

In view of the above, the present disclosure provides methods and apparatuses for attendance configuration.

To achieve the above purpose, the present disclosure provides technical solutions as follows.

In implementations, an attendance configuration method is provided, which includes determining an attendance group related to a community, the attendance group including at least one community member of the community; and initiating an attendance group configuration request to a person in charge of the attendance group to set an attendance condition of the attendance group by the person in charge.

In implementations, an attendance configuration method is provided, which includes receiving an attendance group configuration request for an attendance group, a recipient of the attendance group configuration request being a person in charge of the attendance group; and configuring an attendance condition of the attendance group in response to the attendance group configuration request.

In implementations, a attendance configuration method is provided, which includes determining an attendance group related to a community, the attendance group including at least one community member of the community; initiating an attendance group configuration request to a person in charge of the attendance group; receiving a configuration result returned by the person in charge for the attendance group configuration request; and configuring an attendance condition of the attendance group according to the configuration result.

In implementations, an attendance configuration apparatus is provided, which includes a first attendance group determination unit that determines an attendance group related to a community, the attendance group including at least one community member of the community; and a first requesting unit that initiates an attendance group configuration request to a person in charge of the attendance group to set an attendance condition of the attendance group by the person in charge.

In implementations, an attendance configuration apparatus is provided, which includes a configuration request receiving unit that receives an attendance group configuration request for an attendance group, a recipient of the attendance group configuration request being a person in charge of the attendance group; a configuration unit that configures an attendance condition of the attendance group in response to the attendance group configuration request.

In implementations, an attendance configuration apparatus is provided, which includes a second attendance group determination unit that determines an attendance group related to a community, the attendance group including at least one community member of the community; a second requesting unit that initiates an attendance group configuration request to a person in charge of the attendance group; a third result receiving unit that receives a configuration result returned by the person in charge for the attendance group configuration request; and a configuration unit configures an attendance condition of the attendance group according to the configuration result.

In implementations, an attendance configuration method is provided, which includes determining an attendance group related to a community by a first configuration party, the attendance group including at least one community member of the community; configuring a first attendance condition of the attendance group by the first configuration party; initiating an attendance group configuration request for the attendance group to a second configuration party from the first configuration party; and configuring a second attendance condition of the attendance group by the second configuration party in response to the attendance group configuration request.

In implementations, an attendance configuration apparatus is provided, which includes a third attendance group determination unit that enables includes a first configuration party to determine an attendance group related to a community, the attendance group including at least one community member of the community; a first configuration unit that causes the first configuration party to configure a first attendance condition of the attendance group; a third requesting unit that causes the first configuration party to initiate an attendance group configuration request for the attendance group to a second configuration party; and a second configuration unit that causes the second configuration party to configure a second attendance condition of the attendance group in response to the attendance group configuration request.

As can be seen from the above technical solutions, the present disclosure can realize a fast and accurate attendance configuration operation through innovative attendance configuration solutions.

### BRIEF DESCRIPTION OF THE DRAWINGS

FIG. 1 is a schematic structural diagram of a call prompting system according to an exemplary embodiment.

FIG. 2 is a flowchart of an attendance configuration method according to an exemplary embodiment.

FIG. 3 is a flowchart of another attendance configuration method according to an exemplary embodiment.

FIG. 4 is a flowchart of another attendance configuration method according to an exemplary embodiment.

FIG. 5 is a schematic diagram of an attendance group management interface according to an exemplary embodiment.

FIGS. 6 and 7 are schematic diagrams of attendance personnel selection interfaces according to an exemplary embodiment.

FIG. 8 is a schematic diagram of an attendance group setting interface according to an exemplary embodiment.

FIG. 9 is a schematic diagram of a collective modification attendance group according to an exemplary embodiment.

FIG. 10 is a schematic diagram of an attendance configuration invitation interface according to an exemplary embodiment.

FIG. 11 is a schematic diagram of a report status viewing interface according to an exemplary embodiment.

FIG. 12 is a schematic diagram of a person-in-charge-side work notification interface according to an exemplary embodiment.

FIG. 13 is a schematic diagram of an attendance configuration interface according to an exemplary embodiment.

FIG. 14 is a schematic diagram of a positioning information correction interface according to an exemplary embodiment.

FIG. 15 is a schematic diagram of an administrator-side work notification interface according to an exemplary embodiment.

FIG. 16 is a schematic diagram of a configuration result viewing interface provided by an exemplary embodiment.

FIG. 17 is a schematic structural diagram of an electronic device according to an exemplary embodiment.

FIG. 18 is a block diagram of an attendance configuration apparatus according to an exemplary embodiment.

FIG. 19 is a schematic structural diagram of another electronic apparatus according to an exemplary embodiment.

FIG. 20 is a block diagram of another attendance configuration apparatus according to an exemplary embodiment.

FIG. 21 is a schematic structural diagram of still another electronic device according to an exemplary embodiment.

FIG. 22 is a block diagram of still another attendance configuration apparatus according to an exemplary embodiment.

FIG. 23 is a flowchart of another attendance configuration method according to an exemplary embodiment.

FIG. 24 is a schematic structural diagram of an attendance configuration system according to an exemplary embodiment.

### DETAILED DESCRIPTION

Exemplary embodiments will be described in detail herein, and examples thereof are illustrated in accompanying drawings. When the accompanying drawings are referenced in the following description, the same numerals in different drawings represent the same or similar elements unless indicated otherwise. Implementations described in the following exemplary embodiments do not represent all implementations that are consistent with the present disclosure, but rather are merely examples of apparatuses and methods that are consistent with some aspects of the present disclosure as detailed in the appended claims.

The present disclosure divides community members into a number of attendance groups and initiate attendance group configuration requests to a person in charge of each time attendance group, so that each person in charge can perform attendance configurations for the corresponding time attendance group, instead of having a management member to perform a unified configuration on each attendance group, thus greatly improving the efficiency of configuring the attendance groups.

following embodiments are provided for a further description of the present disclosure.

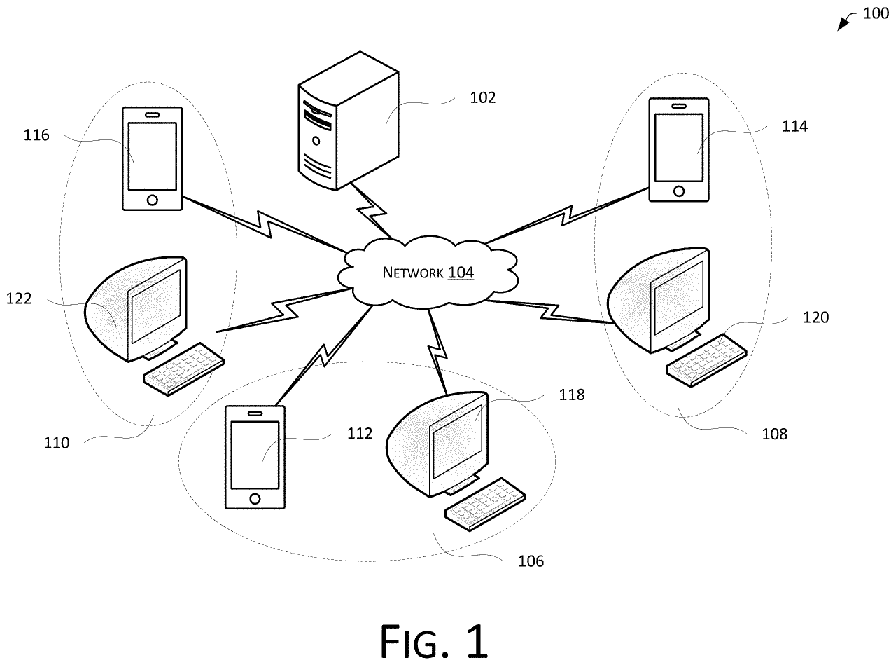

FIG. 1 is a schematic structural diagram of a call prompting system 100 according to an exemplary embodiment. As shown in FIG. 1, the system 100 may include a server 102, a network 104, an electronic device 106 used by a management member, an electronic device 108 used by a person in charge, and an electronic device 110 used by an ordinary member.

The server 102 may be a physical server including an independent host. Alternatively, the server 102 may be a virtual server included in a host cluster. Alternatively, the server 102 may be a cloud server. In a running process, the server 102 can run a server-side program of a certain application to implement related service functions of the application. For example, when the server 102 runs a program of a mobile group work platform, a server end of the mobile group work platform can be implemented, to achieve an attendance function of the embodiments of the present disclosure.

A mobile group work platform can not only implement communication functions, but also serve as an integrated functional platform for a plurality of other functions, processing of internal community events such as approval events (such as leave requests, work item applications, financial and other approval events), attendance events, task events, log events, etc., and processing of external community events such as ordering and purchasing, which are not limited in the present disclosure.

More specifically, a mobile group work platform can host instant communication applications in related technologies, such as Enterprise Instant Messaging (EIM) applications, such as Skype For Business®, Microsoft Communitys®, Yammer®, Workplace®, Slack®, Enterprise WeChat®, Fenixueke®, Enterprise Fetion®, Enterprise Yixin®, etc. Apparently, the instant communication function is only one of the communication functions supported by the mobile group work platform. The mobile group work platform can also implement other functions such as those described above, which will not be exhaustively listed herein.

Other than the mobile phone 112, the mobile phone 114, the mobile phone 116, and PC 118, PC 120, PC 122, etc., as shown in FIG. 1 that can be used for the electronic device 106, the electronic device 108, and the electronic device 110, etc., any other types of electronic devices may also be used, such as tablet devices, notebook computers, personal digital assistants (PDAs), wearable devices (such as smart glasses, smart watches, etc.), etc. The present disclosure has no limitations thereon. During the running process, the electronic devices 13-15 can run respective client-side programs of certain applications to implement relevant service functions of the applications. For example, when the electronic device runs a program of the mobile group work platform, a client end of the mobile group work platform can be implemented to enable a management member to create attendance groups through the electronic device 106, and initiate attendance group configuration requests for respective persons in charge of the attendance groups. A person in charge can configure attendance condition(s) for an attendance group through the electronic device 108, and a community member can perform an attendance operation that meets the attendance condition(s) through the electronic device 110.

Application programs of client ends of a mobile group work platform can be pre-installed on the electronic devices 106-110, so that the client ends can be started and run on the electronic devices 106-110. Apparently, when online “client ends” having technologies such as HTML5 are used, corresponding applications may not be installed on the electronic devices 106-110 to obtain and run the client ends.

The network 104 for interactions between the electronic devices 13-15 and the server 102 may include various types of wired or wireless networks. In implementations, the network 104 may include a Public Switched Telephone Network (PSTN) and the Internet.

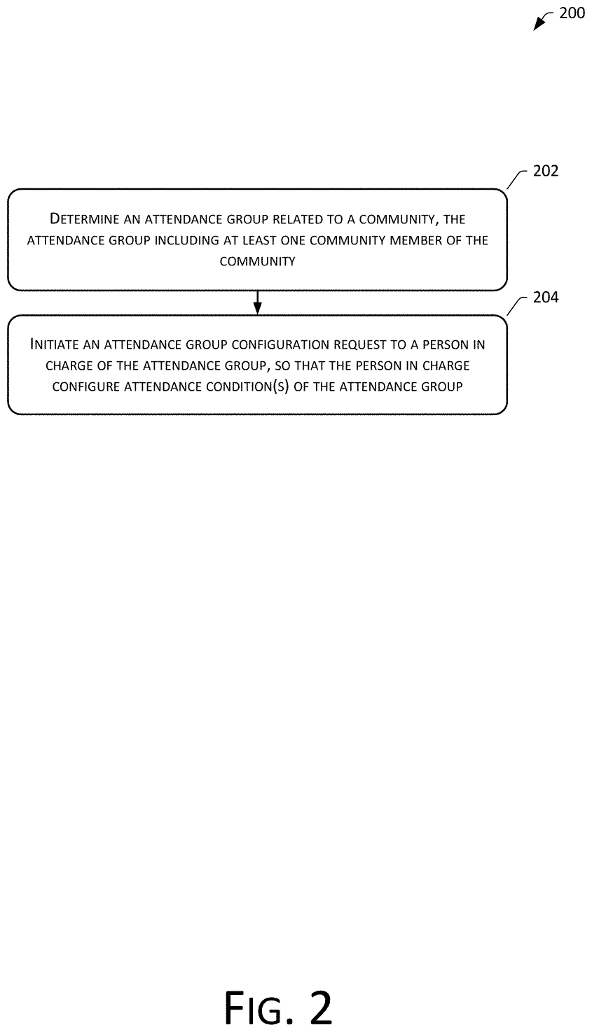

FIG. 2 is a flowchart of an attendance configuration method 200 according to an exemplary embodiment. As shown in FIG. 2, the method 200 can be applied in a server (such as the server 102 shown in FIG. 1). The method 200 may include the following steps.

Step 202: Determine an attendance group related to a community, the attendance group including at least one community member of the community.

In implementations, the community may include any type of collectivity formed in a certain organizational form, such as an enterprise, a school, a hospital, an institution, etc., which is not limited in the present disclosure.

In implementations, community members of a community for a management member may be determined and divided to obtain attendance groups. In other words, the community members may be divided into a plurality of attendance groups by a management member according to an actual situation. The attendance groups may be divided by the management member at any time before step 202. Alternatively, a grouping request may be sent to the management member at step 202, so that the management member may divide the community members into corresponding attendance groups.

In implementations, the management member may include a community member with a management authority in the community, such as an administrator, a creator, a group leader with a management level not lower than a preset management level, or other group member, of the community on the mobile group work platform. The present disclosure does not have any limitations thereon.

In implementations, the management member may not belong to an internal member of the community. For example, the management member may be an externally-administered manager of the community, or a super administrator of the mobile group work platform, etc. The present disclosure does not have any limitations thereon.

In implementations, departmental divisions can be defined based on organizational structure information of the community, and parts of the community can be divided into corresponding attendance groups respectively. Each attendance group includes at least one department in the community. For example, the server end of the mobile group work platform can maintain the organizational structure information of the community. The organizational structure information defines the division of the departments within the community, and the community members can be automatically divided into a plurality of attendance groups based on the division of the departments. A preset division rule can include information of a dimension for dividing the attendance groups. For example, when the dimension is “group”, community members of each group can be divided into an attendance group separately. When the dimension is “department”, community members of each department can be divided into an attendance group separately. Apparently, information of any other dimension can be used, or information of multiple dimensions can be used at the same time. The present disclosure does not have any limitations thereon.

Step 204: Initiate an attendance group configuration request to a person in charge of the attendance group, so that the person in charge configure attendance condition(s) of the attendance group.

In implementations, an attendance group configuration request is used to inform a person in charge of attendance condition(s) to be set. The attendance conditions to be set may be default attendance condition(s) or attendance condition(s) preset by the management member. Correspondingly, a configuration result returned by the person in charge for the attendance group configuration request may be received, and the configuration result includes condition value(s) set by the person in charge for the attendance condition(s) to be configured. For example, when an attendance condition to be set includes a time period of attendance, condition values may be a start time and an end time of the time period of attendance specifically set by the person in charge. When an attendance condition to be set includes a location of attendance, a condition value may be a geographical location of attendance or a region of attendance specifically set by the person in charge. When an attendance condition to be set includes an access point of attendance, a condition value may be information of the wireless access point of attendance specifically set by the person in charge.

In implementations, a condition editing request returned by the person in charge for the attendance condition(s) to be set may be received, and then the attendance condition(s) to be set may be edited according to the condition editing request. For example, if the attendance condition(s) to be set include(s) a time period of attendance and a location of attendance, the person in charge may add a new attendance condition such as an access point of attendance, or may delete one or more attendance conditions, or can implement other editing methods to make to satisfy actual needs of the attendance group.

In implementations, a configuration result returned by the person in charge for the attendance group configuration request may be received, and the configuration result includes attendance condition(s) and corresponding condition value(s) set by the person in charge for the attendance group. In other words, the person in charge can set the attendance condition(s) and respective condition value(s) according to an actual situation of the attendance group.

In implementations, a configuration result returned by the person in charge for the attendance group configuration request may be provided to a management member of the community, and attendance condition(s) of the attendance group may be determined the setting result according to an examination and approval status of the configuration result by the management member. In other words, the management member can examine and approve the configuration result returned by the person in charge to determine whether the configuration result satisfies requirements, avoid situations such as filling errors that may occur for some persons in charge, and ensure a reasonable setting of the attendance condition(s) of the attendance group.

In implementations, a response situation of the person in charge of the attendance group with respect to the attendance group configuration request may be determined, and a reminder message for the attendance group configuration request is sent to the person in charge who has not provided a response yet, to remind the person in charge to set up attendance condition(s) of the attendance group as soon as possible. For example, the reminder message may be sent to the person in charge through at least one of the following ways: initiating a call to the person in charge who has not provided a response yet, and playing a voice content of the reminder message after being connected; sending the reminder message to the person in charge who has not provided a response yet in a form of a short message; sending the reminder message in a form of an instant communication message to the person in charge who has not provided a response yet. Apparently, the reminder message can also be sent in other ways, and the present disclosure does not have any limitations thereon.

In implementations, the attendance condition(s) may include at least one of the following: a time period of attendance, a location of attendance, an access point of attendance. Apparently, the present disclosure does not have any limitations thereon.

In implementations, when receiving the configuration result returned by the person in charge for the attendance group configuration request, the person in charge may be restricted from continuing to set attendance conditions of the attendance group through the attendance group configuration request, thereby avoiding the person in charge to reset the attendance conditions of the attendance group through the attendance group configuration request. This is especially true when such reset may often be caused by a situation such as a false trigger, thus helping the management member to effectively manage attendance conditions of each attendance group. Apparently, if a person in charge really wants to modify a configuration result, he/she may contact the management member individually, and the management member will make a modification on his/her behalf, or the person in charge can modify or reset attendance conditions of his/her attendance group when the management member will issue a attendance group configuration request again.

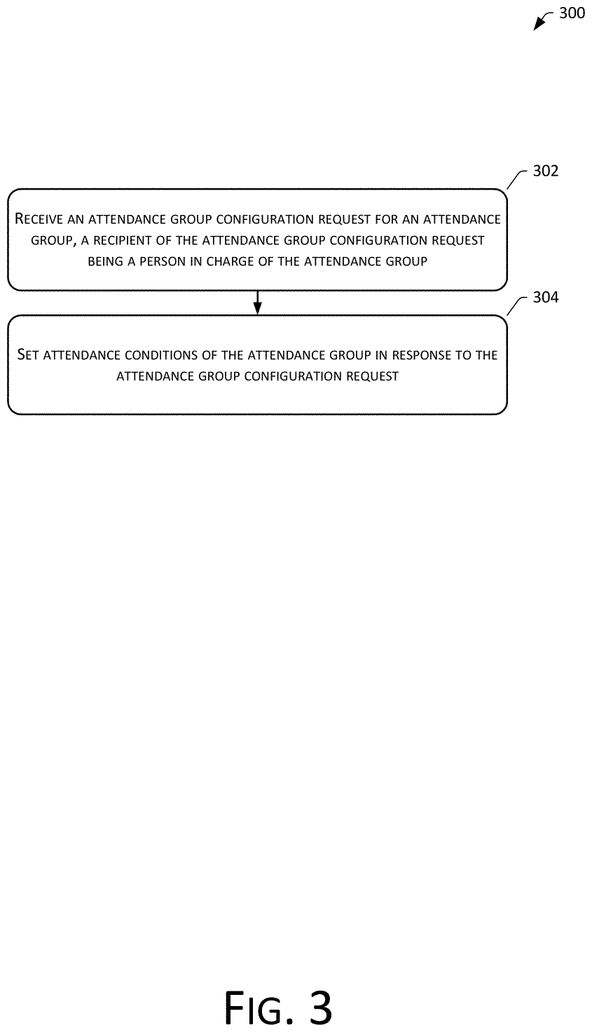

FIG. 3 is a flowchart of another attendance configuration method 300 according to an exemplary embodiment. As shown in FIG. 3, the method 300 may be applied in an electronic device (such as the electronic device 108 shown in FIG. 1). The method 300 may include the following steps.

Step 302: Receive an attendance group configuration request for an attendance group, a recipient of the attendance group configuration request being a person in charge of the attendance group.

Step 304: Set attendance conditions of the attendance group in response to the attendance group configuration request.

In implementations, the attendance conditions may include a location of attendance. When the attendance group configuration request is triggered, candidate locations may be displayed, and the candidate locations may include at least one of: a location where a recipient is located, and a relevant location near the recipient. According to the recipient's selection operation on the candidate locations, a candidate location that is selected is set as the location of attendance. In some cases, a location of attendance desired to be set by a person in charge may not be shown as a candidate location. This is because an electronic device used by the person in charge may encounter a deviation of a positioning operation about the location where the electronic device is located, and the person in charge is currently not present at the location of attendance, or other reasons, etc. The person in charge can modify his/her own location, so that candidate locations that are displayed can be updated according to the modified location for the person in charge to perform a selection again. Alternatively, the person in charge may manually create a location of attendance.

In implementations, the attendance conditions may include an access point of attendance. When the attendance group configuration request is triggered, candidate access points may be displayed, and the candidate access points may include at least one of: an access point detected by an electronic device used by the recipient, and historically detected access point(s) by the electronic device. According to the recipient's selection operation on the candidate access points, a candidate access point that is selected is set as an access point of attendance. An access point (AP) may include a wireless access point, such as a WIFI access point, used for accessing electronic devices. Apparently, the present disclosure does not have any limitations thereon.

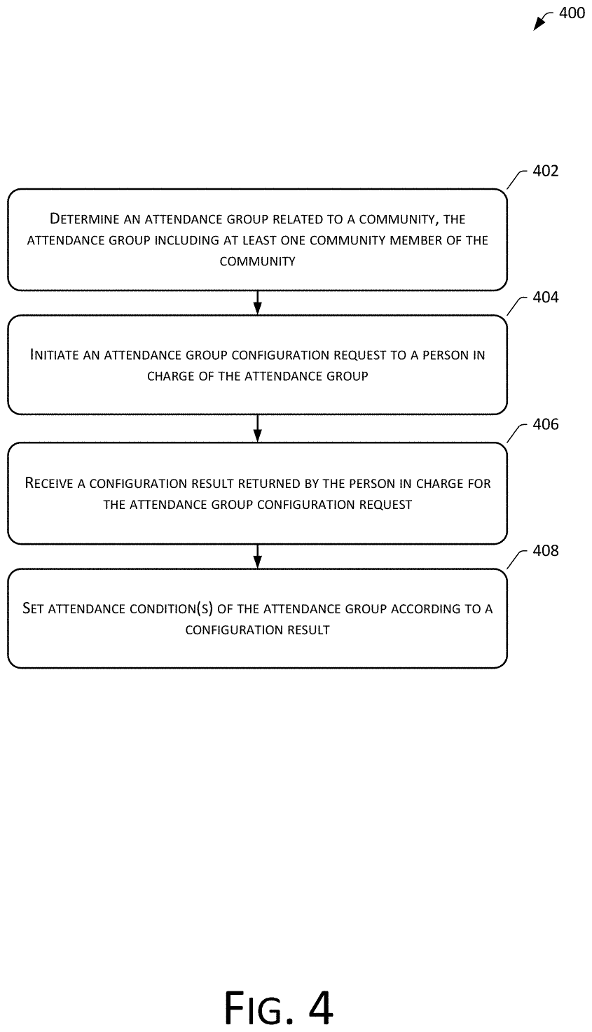

FIG. 4 is a flowchart of another attendance configuration method 400 according to an exemplary embodiment. As shown in FIG. 4, the method 400 may be applied in an electronic device (such as the electronic device 106 shown in FIG. 1). The method 400 may include the following steps.

Step 402: Determine an attendance group related to a community, the attendance group including at least one community member of the community.

In implementations, the attendance group may be set in advance by a management member of the community or other personnel before step 402, and it is only necessary to know a division result of the attendance group in advance at step 402.

In implementations, community members of the community may be divided into corresponding attendance groups by the management member of the group at step 402.

In implementations, the community members can be divided into corresponding attendance groups in any manner.

In implementations, departmental divisions can be defined based on organizational structure information of the community, and parts of the community can be divided into corresponding attendance groups respectively. Each attendance group includes at least one department in the community. For example, organizational structure information of a community defines a division of departments within the community, and the community members can be automatically divided into a plurality of attendance groups based on the division of the departments. A preset division rule can include information of a dimension for dividing the attendance groups. For example, when the dimension is “group”, community members of each group can be divided into an attendance group separately. When the dimension is “department”, community members of each department can be divided into an attendance group separately. Apparently, information of any other dimension can be used, or information of multiple dimensions can be used at the same time. The present disclosure does not have any limitations thereon.

Step 404: Initiate an attendance group configuration request to a person in charge of the attendance group.

Step 406: Receive a configuration result returned by the person in charge for the attendance group configuration request.

In implementations, an attendance group configuration request is used to inform a person in charge of attendance condition(s) to be set. The attendance conditions to be set may be default attendance condition(s) or attendance condition(s) preset by the management member. Correspondingly, a configuration result returned by the person in charge for the attendance group configuration request may be received, and the configuration result includes condition value(s) set by the person in charge for the attendance condition(s) to be configured. For example, when an attendance condition to be set includes a time period of attendance, condition values may be a start time and an end time of the time period of attendance specifically set by the person in charge. When an attendance condition to be set includes a location of attendance, a condition value may be a geographical location of attendance or a region of attendance specifically set by the person in charge. When an attendance condition to be set includes an access point of attendance, a condition value may be information of the wireless access point of attendance specifically set by the person in charge.

The person in charge may initiate a corresponding condition editing request for the attendance condition(s) to be set, so that the attendance condition(s) to be set is/are edited according to the condition editing request. For example, the attendance condition(s) to be set include(s) a time period of attendance and a location of attendance, the person in charge may add a new attendance condition such as an access point of attendance, or delete one or more attendance conditions, or implement other editing methods, to meet actual needs of the attendance group. In one case, a person in charge can initiate a condition editing request to a server end of a mobile group work platform to edit attendance conditions set by the server end. In another case, a person in charge can initiate a condition editing request to a management member, so that attendance condition(s) to be set can be implemented with a corresponding editing operation after the management member confirms an editing solution indicated by the condition editing request.

In implementations, attendance conditions may not be set in the attendance group configuration request, and the person in charge sets attendance condition(s) and respective condition value(s) according to an actual situation of the attendance group, and returns the attendance condition(s) and the respective condition value(s) through a configuration result.

Step 408: Set attendance condition(s) of the attendance group according to a configuration result.

In implementations, a management member may perform an approval operation on the configuration result. When the setting configuration is approved, the attendance condition(s) of the attendance group are set according to the configuration result.

In implementations, if the configuration result fails to pass the approval, the management member may re-initiate the attendance group configuration request to the person in charge, to allow the person in charge to perform a reconfiguration. Alternatively, under normal circumstances, only a small part of the configuration result may not pass the approval. For example, the configuration result obviously does not meet the requirements due to an incorrect filling-in by the person in charge. The management member can manually modify the configuration result without the person in charge to perform a reconfiguration.

To facilitate understanding, an enterprise instant communication application is used as an example to explain the technical solutions of the present disclosure. Instant communication client ends are assumed to be run on PC131, the mobile phone 132, and the mobile phone 114, and an instant communication server end is assumed to be run on the server 102. The instant communication client ends on PC131, the mobile phone 132, and the mobile phone 114 respectively have been logged in with registered accounts of different users. For example, PC131 and the mobile phone 132 are logged in with a registered account of a user A, who acts as a management member. As such, PC131 and the mobile phone 132 are configured as an instant communication client end 1 corresponding to the user A, and the mobile phone 114 is logged in with a registered account of a user B, who acts as a person in charge of an attendance group. As such, the mobile phone 114 is configured as an instant communication client end 2 corresponding to the user B.

For example, the user A and the user B are both assumed to be members of an enterprise AA. The user A creates one or more attendance groups through the instant communication client end 1, and the user B is a person in charge of a certain attendance group (each attendance group may have one or more persons in charge, and a person in charge is usually a member of a corresponding attendance group). The person in charge such as the user B separately sets an attendance configuration of a corresponding attendance group. The user B is used as an example. The user B may use the instant communication client end 2 to implement an attendance configuration. Operations and interaction processes of the user A and the user B are described below for introducing the technical solutions of the present disclosure.

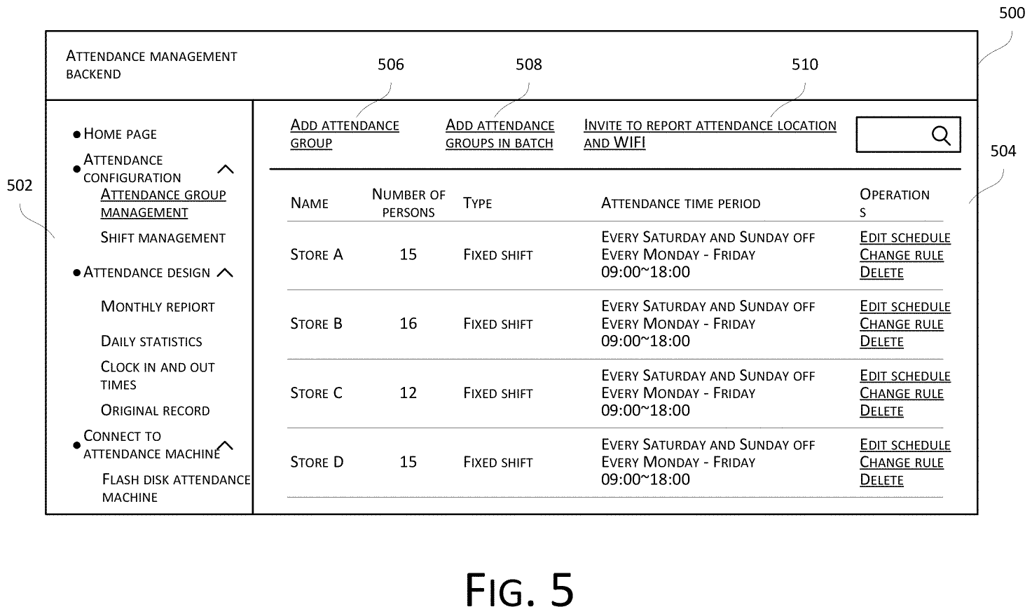

FIG. 5 is a schematic diagram of an attendance group management interface according to an exemplary embodiment. If the user A uses PC 118 as shown in FIG. 1 to implement attendance group management such as creating an attendance group, PC 118 can provide an attendance group management interface 500 as shown in FIG. 5 to user A for implementing the attendance group management. As shown in FIG. 5, the attendance group management interface 500 may include an option list 502. The option list 502 may include a number of options such as a home page, an attendance configuration, attendance statistics, and connection to an attendance machine, etc. Each option may further include a number of sub-options. For example, an option of attendance configuration may further include sub-options such as an attendance group management, a shift management, etc. When the user A selects the “attendance group management” sub-option in the “attendance configuration”, a display area 504 may be shown with corresponding display content of the “attendance group management” sub-option.

In implementations, the display area 504 may display information of attendance group(s) that has/have been created. As shown in FIG. 5, information of an attendance group that has been created may include “name”, “number of persons”, “type”, “attendance time”, etc. For example, the name of a certain attendance group is “store A”, and the number of persons is “15”, the type thereof is “fixed shift”, and the attendance time is “days off on every Saturday and Sunday” and “Monday through Friday 09:00˜18:00”. Information of each attendance group that has been created may be displayed in an order of arrangement as shown in FIG. 5. For an attendance group that has been created, editing functions such as “edit schedule”, “modify rule”, “delete”, etc. may be implemented by the user A

In implementations, the display area 504 may display a plurality of functional options. As shown in FIG. 5, the function options may include an option 506 used for implementing an “Add Attendance Group” function, an option 508 used for implementing a “Batch Add” function, and an option 510 used for implementing an “Invite to Report Attendance Location and WIFI” function, etc. In response to detecting that the user A triggers the option 506, a single attendance group may be added. In response to detecting that the user A triggers the option 508, multiple attendance groups may be added in a batch. A process of adding in a batch is described in detail in the following text. In response to detecting that the user A triggers the option 510, a person in charge may be invited to report an attendance location and WIFI. The attendance group may include a pre-created attendance group that has not been configured with attendance conditions, or may include an attendance group that has already been configured with attendance conditions and needs to be reconfigured.

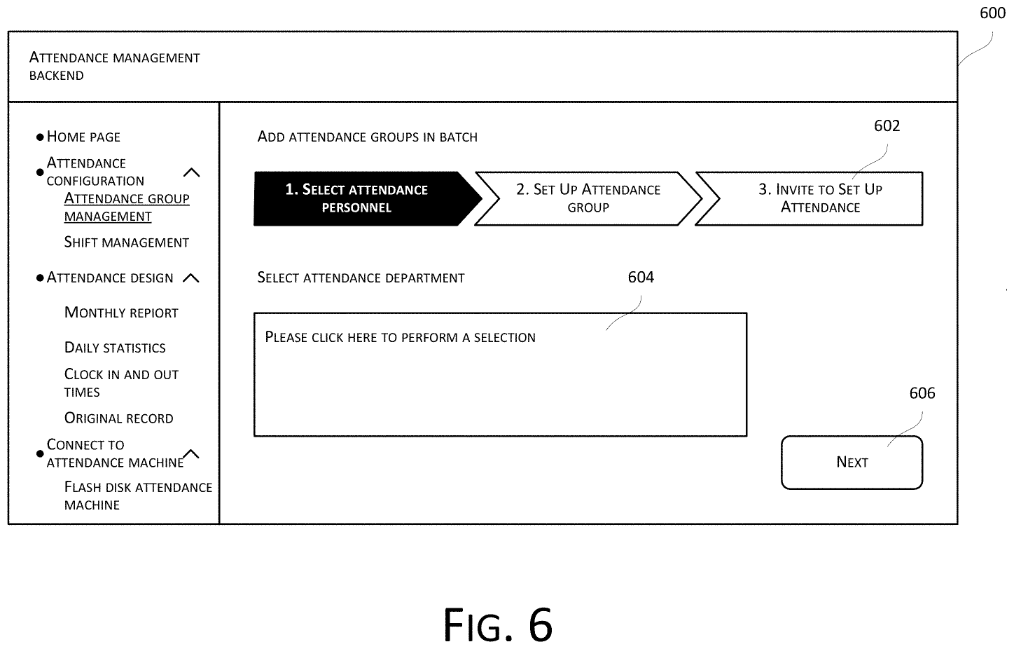

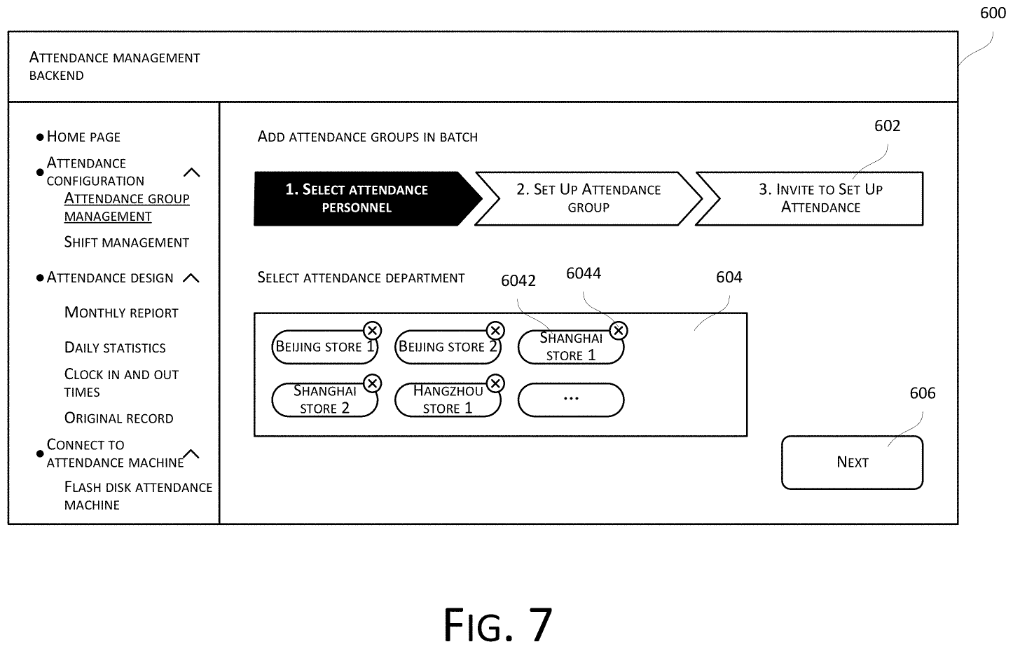

FIGS. 6 and 7 are schematic diagrams of attendance personnel selection interfaces according to an exemplary embodiment. In response to detecting that the option 508 shown in FIG. 5 is triggered, a transfer to an attendance selection interface 600 as shown in FIG. 6 may be made to allow the user A to select a person to be added into an attendance group to be created. As shown in FIG. 6, progress information 602 of “Batch Add Attendance Group” may be displayed in the attendance selection interface 600. The progress information 602 may include a plurality of stages, such as “1. Select Attendance Personnel”, “2. Set Up Attendance Group”, “3. Invite to Set Up Attendance”, etc. in which a current stage is distinguished from other stages by using different display attributes, to facilitate a user to quickly distinguish the current stage. For example, the current stage in FIG. 6 is “1. Select Attendance Personnel”.

In the attendance selection interface 600, a selection box 604 may be provided to the user A, to allow the user A to select a person who needs to be added to an attendance group to be created. When the user A is an administrator of the enterprise AA, the selection box 604 may be used by the user A to select attendance personnel from the enterprise members of the enterprise AA. For example, in response to detecting that the selection box 604 is triggered by the user A, organizational structure information of the enterprise AA may be displayed to the user A. The organizational structure information may include various departments within the enterprise AA, so that the user A may select one or more departments, thus allowing a quick selection of all the enterprise members under the entire department(s). Apparently, in other embodiments, the user A may also determine the attendance personnel in other ways, such as individually selecting each enterprise member from the organizational structure information, instead of make a selection by department. For another example, methods other than the organizational structure information may be used for selecting the attendance personnel. The present disclosure does not have any limitations thereon.

If the user A selects several departments through the organizational structure information of the enterprise AA (enterprise members in these departments are configured as corresponding attendance personnel), the instant communication client end 1 may display identification information corresponding to each department in the selection box 604, for example, “Beijing Store 1”, “Beijing Store 2”, “Shanghai Store 1”, “Shanghai Store 2”, “Hangzhou Store 1”, etc., as shown in FIG. 7. “Shanghai Store 1” is used as an example. The identification information shown in FIG. 7 may include a departmental name 6042, a management identifier 6044, etc. The departmental name 6042 is used for allowing the user A to view and confirm, and the management identifier 6044 is used for allowing the user A to manage corresponding identification information. For example, when the user A triggers the management identifier 6044, “Shanghai Store 1” can be deleted from the selection box 604, so that the user A can correct errors or temporarily change requirements.

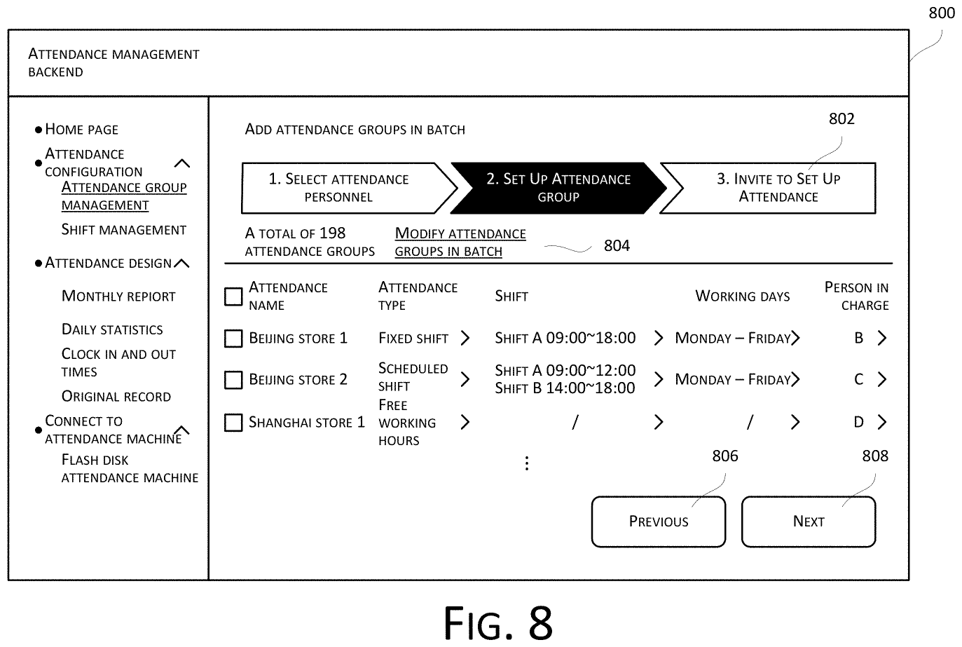

FIG. 8 is a schematic diagram of an attendance group setting interface according to an exemplary embodiment. In response to detecting that the user A triggers a “Next” option 606 as shown in FIG. 7, a determination can be made that the user A has completed the selection of the attendance personnel, and a transfer is made to an attendance group setting interface 800 as shown in FIG. 8. As shown in FIG. 8, progress information 802 of “Add Attendance Groups in Batch” can be displayed in the attendance group setting interface 800, and the progress information 802 indicates that the current stage is “2. Set Up Attendance Group”.

As shown in FIG. 8, the attendance group setting interface 800 may display attendance group(s) and related information of the attendance personnel that the user A has selected. The attendance personnel can be divided into corresponding attendance groups in various ways. In implementations, the instant communication client end 1 or the instant communication server end may create corresponding attendance group(s) for each department selected by the user A according to the organizational structure information of the enterprise AA, and obtain the corresponding attendance groups of the departments such as “Beijing Store 1”, “Beijing Store 2”, “Shanghai Store 1”, etc. Since the instant communication server end or the instant communication client end 1 can maintain the organizational structure information of the enterprise AA, corresponding attendance groups can be automatically generated based on the organizational structure information to achieve fast, automatic and batch generation of the attendance groups. In other embodiments, the user A may also create attendance group(s) in other ways, such as adding attendance personnel to an attendance group in a unit of “individual”, which are not limited in the present disclosure.

For an attendance group that is created, the attendance group setting interface 800 can display an attendance group name, an attendance type, a shift, working days, a person in charge, and other information for user A to perform viewing and configurations.

In implementations, the “attendance group name” may be a departmental name in the organizational structure information by default, which is apparently not limited in the present disclosure.

In implementations, the “attendance type”, the “shift”, and the “working day” are used to limit an attendance time period of each attendance group. An attendance group of the “Beijing Store 1” is used as an example. An attendance type thereof may be a “fixed shift”, a shift may be a “shift A 09:00˜18:00”, and working days may be “Monday through Friday”. The “Beijing Store 2” is also used as an example. An attendance type thereof may be “scheduled shift”, a shift may be “shift A 09:00˜12:00, and shift B 14:00˜18:00”, and working days may be “Monday through Friday”. The “Shanghai Store 1” is further used as an example. An attendance type thereof may be “free working hours”, a shift and working days may be “null” (in the case of “free working hours”, no setting is needed). The user A can set or edit an “attendance type”, a “shift”, and “working days” of each attendance group according to actual needs. For example, when a “>” sign on the right side of the “fixed shift” of the attendance group of the “Beijing Store 1” is triggered, the user A can change the “attendance type” of the attendance group of “Beijing Store 1” from the “fixed shift” to another type such as the “scheduled shift”, or “free working hours”, etc. Methods for editing other options such as “shift” and ‘working days” are similar thereto, and are not redundantly described herein.

It should be noted that, in some scenarios, the user A can set a portion of attendance conditions such as the “attendance time period”, and a person in charge of the attendance group may set other attendance conditions in a subsequent stage. In other scenarios, the user A does not need to set any attendance conditions, and the person in charge of the attendance group sets all the attendance conditions in the subsequent stage. The present disclosure does not have any limitations thereon.

In implementations, a “person in charge” is used to show a person in charge of each attendance group. For example, a person in charge of the attendance group of “Beijing Store 1” is the user B, and a person in charge of the attendance group of “Beijing Store 2” is the user C, and a person in charge of the attendance group of “Shanghai Store 1” is the user D, etc. Each attendance group can have one or more persons in charge. When an attendance group corresponds to one or more departments, enterprise member(s) who is/are the leader(s) of the department(s) can be automatically configured as person(s) in charge of the attendance group. Alternatively, the user A can set a required person in charge according to an actual situation. The attendance group of the “Beijing Store 1” is used as an example. The user A can edit the person in charge of the attendance group of the “Beijing Store 1” by triggering a “>” sign on the right side of “B”.

In the embodiment shown in FIG. 8, a total of 198 attendance groups are created. The user A may need to spend more time to edit each attendance group one by one. In implementations, in response to detecting that the user A triggers a “Modify Attendance Group” option 804 as shown in FIG. 8, several attendance groups can be edited simultaneously. In one case, a “□” sign is displayed on the far left of each attendance group. The user A can check respective “□” signs corresponding to multiple attendance groups, or select all attendance groups at the same time through a “□” on the left side of “Attendance Name”, and then trigger the “Modify Attendance Group” option 804 to edit all the attendance groups selected by the user A at the same time. In another case, the user A can directly trigger the “Modify Attendance Group” option 804, and the instant communication client end 1 can treat the user A desiring to edit all the attendance groups at the same time by default.

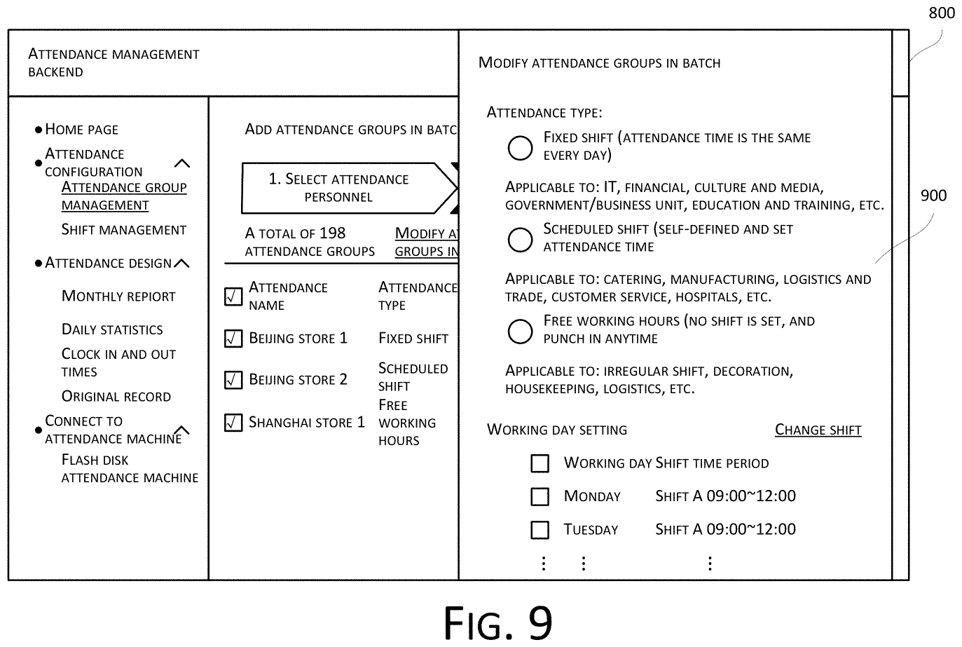

FIG. 9 is a schematic diagram of modifying attendance groups in a batch according to an exemplary embodiment. In response to detecting that the user A triggers a “Modify Attendance Group in Batch” option 804 as shown in FIG. 8, a batch modification attendance group window 900 shown in FIG. 9 can be displayed to the user A to perform editing on multiple selected attendance groups in a batch, without the need of having to edit each attendance group one by one. As shown in FIG. 9, the batch modification attendance group window 900 can be used to edit “attendance type”, “working days”, etc. For example, the user A can set the “attendance type” to “fixed shift”, “scheduled shift”, or “free working hours”, etc., for all selected attendance groups at the same time. The user A can also modify working days or shift time periods of the working days for all the selected attendance groups at the same time.

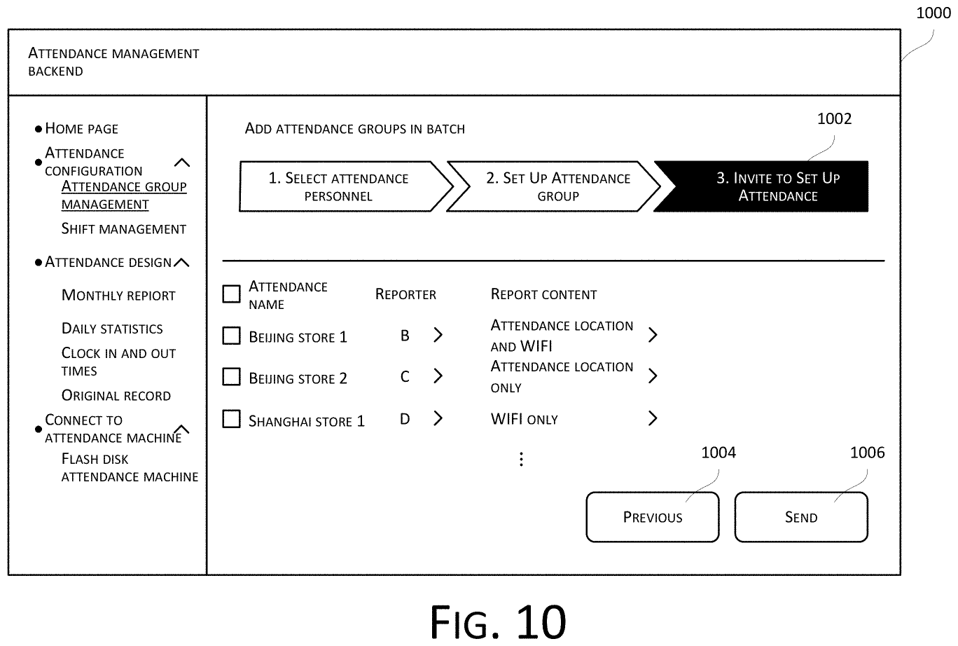

In the attendance group setting interface 800 shown in FIG. 8, the user A can return to the attendance selection interface 600 as shown in FIG. 7 by triggering a “Back” option 806, and view or modify the attendance personnel that is to be set. When the user A triggers a “Next” option 808 shown in FIG. 8, a transfer to an invitation setting attendance interface 1000 as shown in FIG. 10 is made to perform subsequent operations.

FIG. 10 is a schematic diagram of an invitation setting attendance interface according to an exemplary embodiment. As shown in FIG. 10, progress information 1002 of “Add Attendance Group in Batch” can be displayed in the invitation setting attendance interface 1000, and the progress information 1002 indicates that the current stage is “3. Invite to Set Up Attendance”.

Attendance groups that are created, a reporting person (i.e., a person in charge) of each attendance group, and attendance information that needs to be reported by the person in charge can be displayed in the invitation setting attendance interface 1000. For example, a reporting person of the attendance group of “Beijing Store 1” is the user B, and attendance information that needs to be reported is “Attendance Location and WIFI”. A reporting person of the attendance group of “Beijing Store 2” is the user C, and attendance information that needs to be reported is “Attendance Location Only”. A reporting person of the attendance group of “Shanghai Store 1” is the user D, and attendance information that needs to be reported is “WIFI Only”. The “Beijing Store 1” is used as an example. By triggering a “>” sign on the right side of the user B, the user A can edit the person in charge. By triggering a “>” sign on the right side of “Attendance Location and WIFI”, the user A can edit reported content.

In implementations, the user A can trigger a “back” option 1004 to return to the attendance group setting interface 800 as shown in FIG. 8 to view or modify configuration information of an attendance group. In another embodiment, the user A may trigger a “send” option 1006 to send an attendance group configuration request for a corresponding attendance group to a respective person in charge of each attendance group, so that the respective person in charge can perform attendance configuration for each attendance group, without the need for the user A to perform configurations one by one, which can greatly improve the efficiency of configuration of these attendance groups, and avoid the user A from making configuration errors during the process of configuration for a large number of attendance groups.

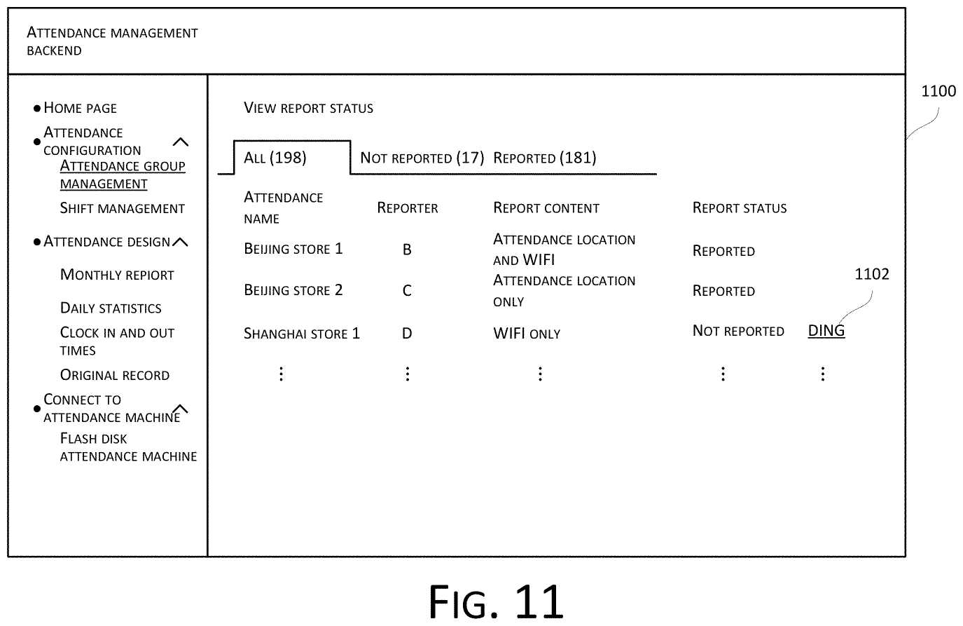

FIG. 11 is a schematic diagram of a report status viewing interface according to an exemplary embodiment. As shown in FIG. 11, after the user A sends an attendance group configuration request to a respective person in charge of each attendance group, a report status viewing interface 1100 can be used to view configuration statuses of these person in charge of the attendance groups. For example, “All (198)” indicates that there are 198 attendance groups in total, and a display list corresponding to “All (198)” includes configuration statuses of all these attendance groups. For example, a reporter of the attendance group of the “Beijing Store 1” is the user B, report content is “attendance location and WIFI”, and a report status is “reported”, which indicate that the user B has completed the attendance configuration of the attendance group of the “Beijing Store 1”. For another example, a reporter of the attendance group of the “Shanghai Store 1” is the user D, report content is “WIFI only”, and a report status is “not reported”, which indicate that user D has not completed the attendance configuration of the attendance group of the “Shanghai Store 1”. For another example, “Not Reported (17)” indicates that 17 attendance groups have not completed attendance configurations. The user A can trigger “Not Reported (17)” as shown in FIG. 11 to view these attendance groups that have not completed the attendance configurations and respective related information individually. “Reported (181)” indicates that 181 attendance groups have completed attendance configurations. The user A can trigger “Reported (181)” as shown in FIG. 11 to view these attendance groups that have completed attendance configurations individually and respective related information.

In implementations, for the attendance group that has not completed an attendance configuration, such as the attendance group of the “Shanghai Store 1” as shown in FIG. 11, a corresponding reminder option 1102 can be displayed in the report status viewing interface 1100, so that the user A can trigger this reminder option 1102 sends a reminder message to the person in charge (the user D) of the attendance group of “Shanghai Store 1”, to remind the person in charge to complete operations of the attendance configuration as soon as possible. The reminder message can be sent in a plurality of different ways, which are not limited in the present disclosure. For example, in one case, the instant communication server end can initiate a call to the user D, and the message content of the reminder message is played to the user D in a voice format after the call is connected. In another case, the instant communication server end can send a short message to the user D, and the message contains the message content of the reminder message. In another case, the instant communication server end can send a message to the user D sends an instant communication message, and the instant communication message includes the message content of the reminder message.

The person in charge (the user B) of the attendance group of the “Beijing Store 1” is used as an example below to describe a process of implementing attendance configuration for the person in charge.

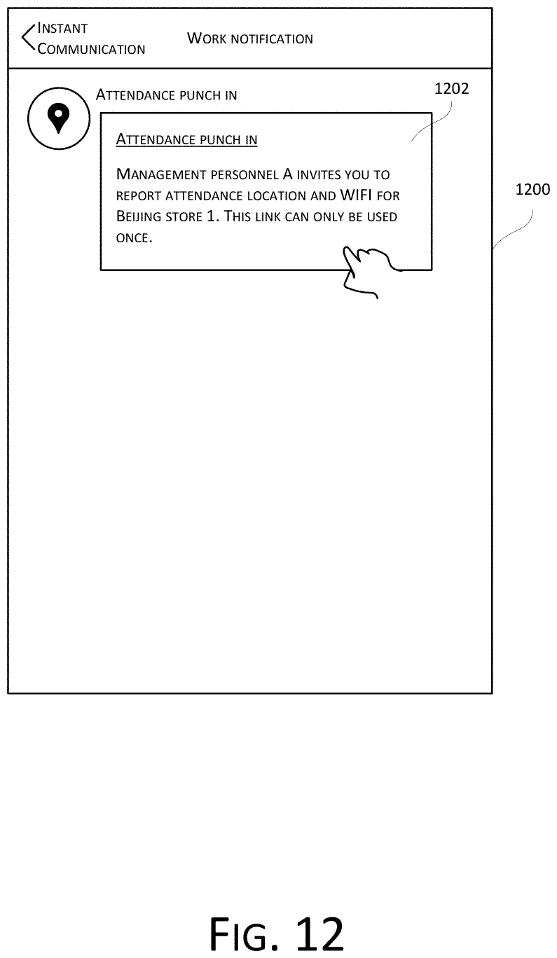

FIG. 12 is a schematic diagram of a person-in-charge-side work notification interface provided by an exemplary embodiment. As shown in FIG. 12, the instant communication client end 2 may provide a work notification interface 1200, which is used to display a communication message of a “work notification” type received by the instant communication client end 2. In implementations, when the user A and the user B both belong to the enterprise AA and the user A is an administrator of the enterprise AA, messages sent by the user A (who acts as an administrator) to the user B can be considered to be communication messages of a “work notification” type, and are displayed in the work notification interface 1200 as shown in FIG. 12.

As shown in FIG. 12, when the user A initiates an attendance group configuration request to the user B through the invitation setting attendance interface 1000 as shown in FIG. 10, the instant communication client end 2 can receive and display the attendance group configuration request as a notification message 1202 in a work notification interface 1200. The user B can trigger the notification message 1202 to implement an attendance configuration of the attendance group of the “Beijing Store 1”.

In implementations, the notification message 1202 shown in FIG. 12 records that “this link can only be uploaded once”. In response to the notification message 1202, the user B can use the attendance configuration interface 1300 described below to perform an attendance configuration for the attendance group of the “Beijing Store 1”. After the user B completes the configuration and returns a configuration result to the user A, the user B can no longer perform attendance configuration on the attendance group of the “Beijing Store 1” through the notification message 1202 again, so as to avoid that the user B to repeatedly modify the attendance group of the “Beijing Store 1”, thus facilitating the user A to manage each attendance group.

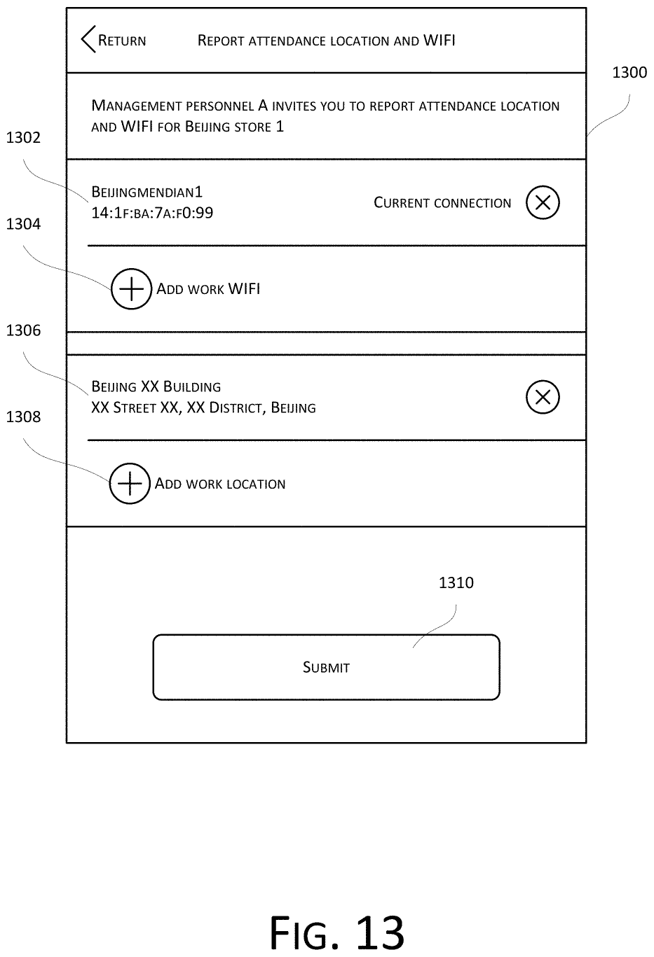

FIG. 13 is a schematic diagram of an attendance configuration interface according to an exemplary embodiment. In response to detecting that a triggering operation of the user B on the notification message 1202, a transfer to the attendance configuration interface 1300 as shown in FIG. 13 can be made to enable setting of an attendance location and an attendance WIFI of the attendance group of the “Beijing Store 1”, where: “Attendance Location” is used for limiting a geographical location for an attendance personnel to perform attendance operations. The attendance personnel can only perform attendance operations when he/she is located in the “Attendance Location”. The attendance WIFI is used for limiting a geographical location for the attendance personnel to perform attendance operations, and an electronic device of the attendance personnel can access the “Attendance WIFI” only if electronic device is located within a local area coverage of the “Attendance WIFI”.

As shown in FIG. 13, the attendance configuration interface 1300 may display candidate geographic locations and candidate WIFI for the user B to select an attendance location and an attendance WIFI. For example, the candidate WIFI may include a WIFI access point to which an electronic device used by the user B is currently connected, and corresponding access point information 1302 is displayed in the attendance configuration interface 1300. For example, the access point information 1302 may include a name of an access point “Beijingmendian1”, a MAC address of the access point “14:1f:ba:7a:f0:99”, etc. The candidate WIFI may also include other types of WIFI access points, such as WIFI access points that were accessed by the electronic device of the user B in the past. The present disclosure does not have any limitations thereon. The user B can configure one or more attendance WIFI. For example, the user B can trigger another add option 1304 in the attendance configuration interface 1300 to add other WIFI access points as attendance WIFI. The user B can also delete a WIFI access point in the attendance configuration interface 1300. For example, the user B can trigger a “0” sign on the right side of the access point information 1302 to delete a WIFI access point corresponding to the access point information 1302. The user B can also delete other WIFI access points in a similar manner, which is not redundantly described herein.

The candidate geographic locations may include a geographic location where the electronic device used by the user B is currently located, and corresponding geographical location information 1306 may be shown in the attendance configuration interface 1300. For example, the geographical location information 1306 may include a name of a landmark building “Beijing XX Building”, a specific address “XX Street XX, XX District, Beijing”, etc. The candidate geographical locations may also include other types of geographical locations, such as a geographical location where the user B has often been located in the past, any geographical location that is specified by the user B, etc. The present disclosure does not have any limitations thereon. The user B can configure one or more attendance geographical locations. For example, the user B can trigger an add option 1308 in the attendance configuration interface 1300 to add other geographical locations as attendance geographical locations. The user B can also delete a geographical location in the attendance configuration interface 1300. For example, the user B can trigger a “0” sign on the right of the geographical location information 1306 to delete a geographical location corresponding to the geographical location information 1306. The user B can also delete other geographical locations in a similar manner, which is not redundantly described herein.

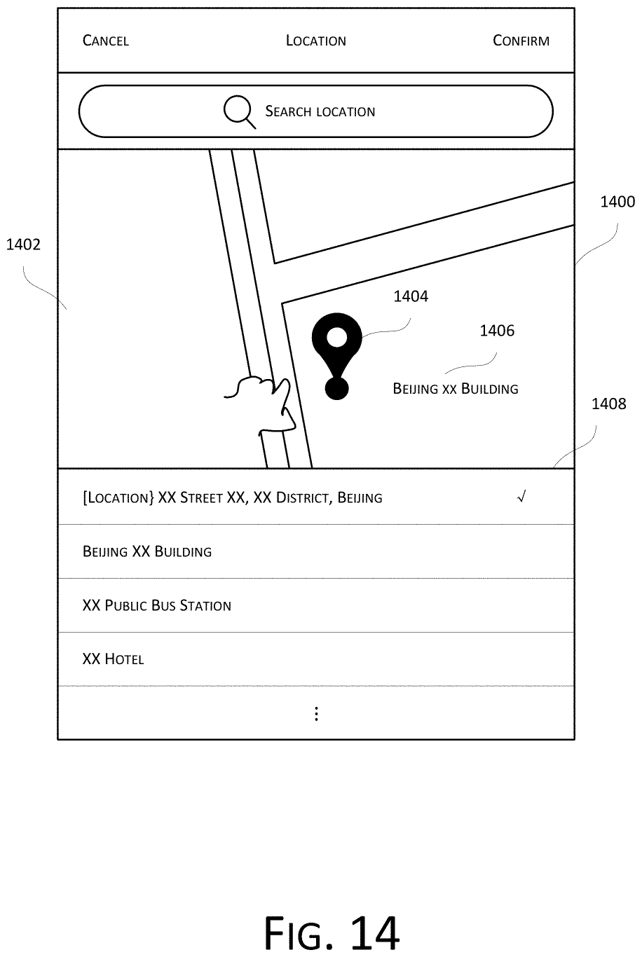

FIG. 14 is a schematic diagram of a positioning information correction interface according to an exemplary embodiment. When positioning information of a certain geographical location is inaccurate, the user B can correct the positioning information. The geographical location information 1306 is used as an example. In response to detecting a triggering operation of the user B on the geographical location information 1306, a transfer to a positioning information correction interface 1400 shown in FIG. 14 may be performed, and the positioning information correction interface 1400 may include a map display area 1402. The map display area 1402 may show a positioning indicator 1404 corresponding to a current position of the electronic device used by the user B, a landmark building 1406 near the current position, and map information of a neighborhood thereof. The positioning information correction interface 1400 may further include a point of interest (POI) list 1408. The point of interest list 1408 is used to display information about points of interest in the map display area 1402, such as “Beijing XX Building”, “XX bus station”, “XX hotel”, etc., in FIG. 14, to allow the user B to determine and select an attendance location that needs to be set. For example, when the electronic device used by user B is positioned as “XX, XX Street, XX District, Beijing”, the user B can select “Beijing XX Building” in the point of interest list 1408 if the user B wants to set the attendance location to “Beijing XX Building”. Alternatively, the user B can directly move the positioning indicator 1404 in the map display area 1402 to “Beijing XX Building”, to enable the electronic device the correct the “current position” to “Beijing XX Building”.

After the user B finishes setting the attendance location and the attendance WIFI, he/she may trigger a “submit” option 1310 as shown in FIG. 13 to return a configuration result for the above attendance group configuration request to user A, so that the user A can view a reporting status corresponding to the attendance group of the “Beijing Store 1” as “reported” in the report status viewing interface 1100 shown in FIG. 11.

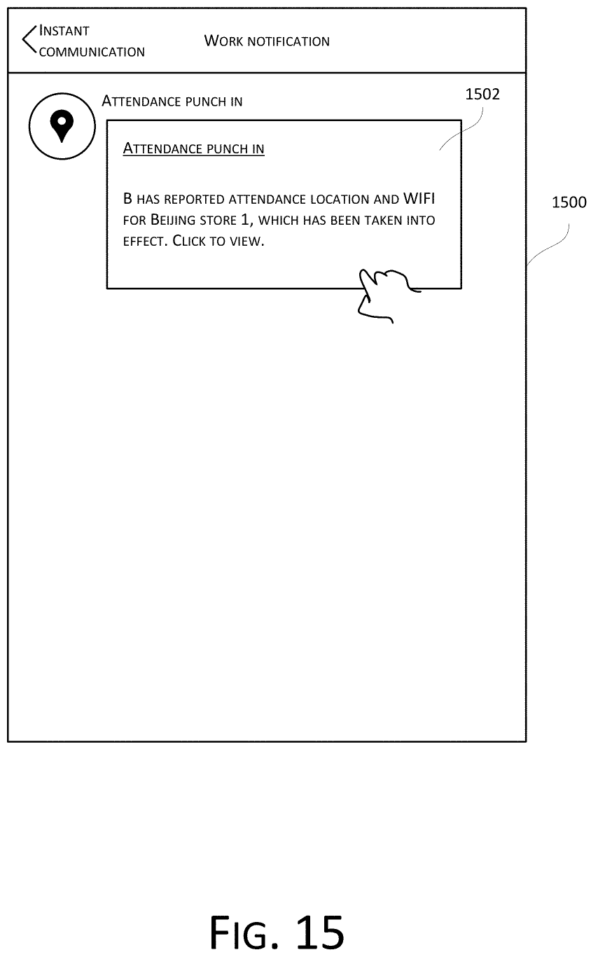

FIG. 15 is a schematic diagram of an administrator-side work notification interface according to an exemplary embodiment. As shown in FIG. 15, the instant communication client end 1 can display a work notification interface 1500 to the user A, and display a report notification message 1502 corresponding to the configuration result returned by the user B in the work notification interface 1500. Similarly, when persons in charge of other attendance groups return configuration results, corresponding report notification messages can usually be displayed in the work notification interface 1500, which is not repeatedly described herein.

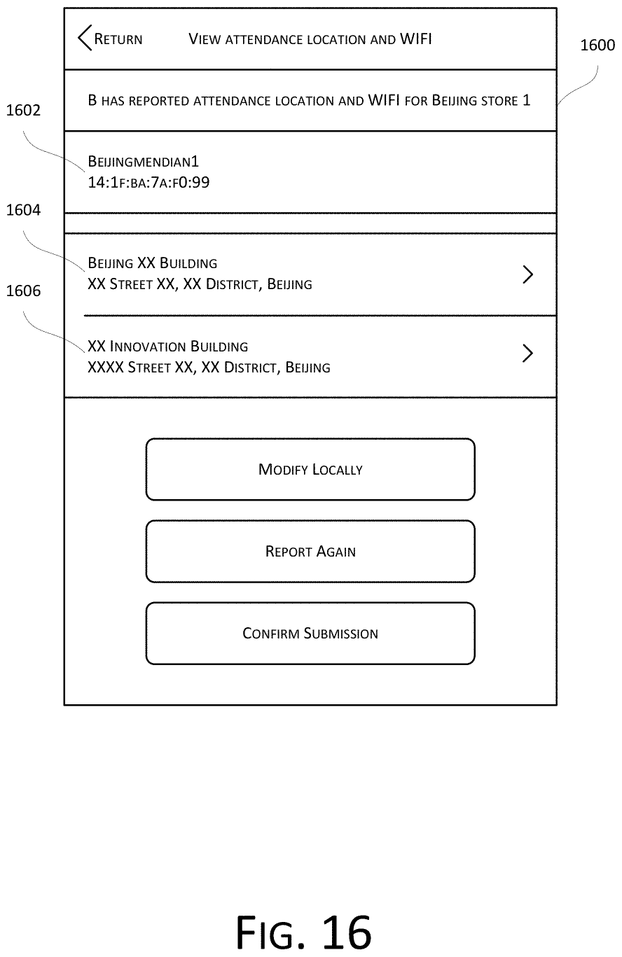

FIG. 16 is a schematic diagram of a configuration result viewing interface according to an exemplary embodiment. In response to detecting that the user A triggers the report notification message 1502, a transfer to the configuration result viewing interface 1600 as shown in FIG. 16 can be made to view attendance conditions set by the user B for the attendance group of the “Beijing Store 1”, for example, WIFI information 1602 for attendance WIFI, a first place 1604 and a second place 1606 for attendance locations.

In implementations, the configuration result viewing interface 1600 may provide a “modify locally” option, so that the user A is allowed to modify attendance conditions of the attendance group of the “Beijing Store 1” on the instant communication client end 1 when the user A does not recognize the attendance conditions set by the user B.

In implementations, the configuration result viewing interface 1600 may provide a “report again” option, so that the user A can re-initiate an attendance group configuration request to the user B by triggering the “report again” option to allow the user B to reconfigure the attendance conditions corresponding to the attendance group of the “Beijing Store 1” when the user A does not recognize the attendance conditions set by the user B.

In implementations, the configuration result viewing interface 1600 may provide a “confirm submission” option, so that the user A can use the configuration result to configure the attendance conditions corresponding to the attendance group of the “Beijing Store 1” when the user A recognizes the attendance conditions set by user B. In another embodiment, the configuration result returned by the user B may be used by default to directly configure the attendance conditions corresponding to the attendance group of the “Beijing Store 1”, and the configuration result viewing interface 1600 is only used to allow the user A to perform viewing, and does not require the user A to “confirm submission”. Apparently, if the user A does not recognize the attendance conditions set by the user B, the user A can still use the “modify locally” option, the “report again” option, or other methods to perform adjustments on corresponding attendance conditions of the attendance group of the “Beijing Store 1”.

In short, through the technical solutions of the present disclosure, an administrator can respectively initiate attendance group configuration requests to respective persons in charge of multiple attendance groups, so that these persons in charge can make attendance configurations for the corresponding attendance groups without the need of the administrator to perform configurations one after one, thus greatly improving the efficiency and accuracy of configurations of attendance conditions (administrators are prone to configuration errors during a long period of time and a large number of configuration operations).

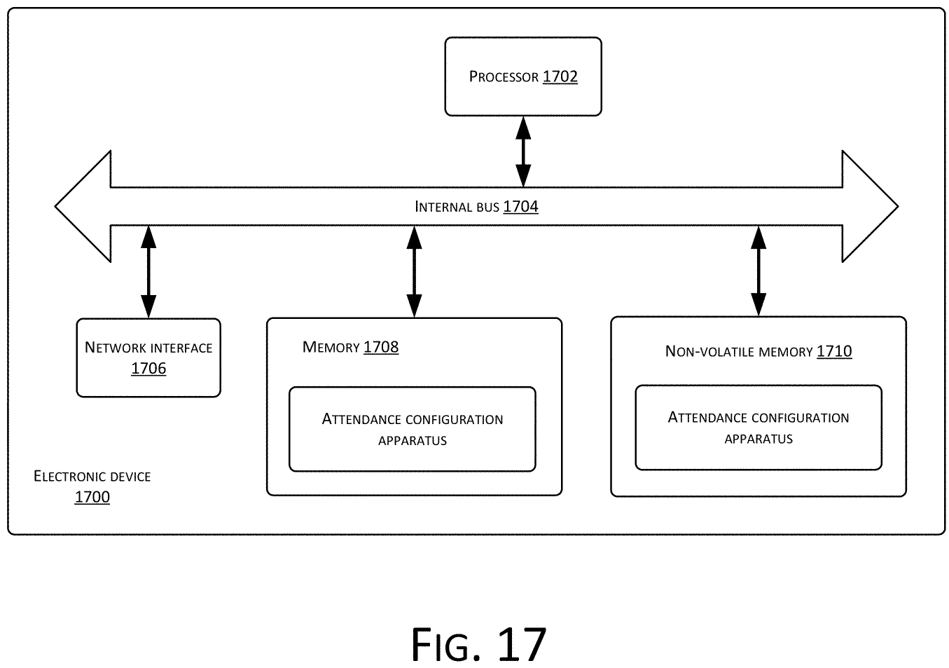

FIG. 17 is a schematic structural diagram of an electronic device 1700 according to an exemplary embodiment. Referring to FIG. 17, at a hardware level, the electronic device 1700 includes a processor 1702, an internal bus 1704, a network interface 1706, a memory 1708, and a non-volatile memory 1710, and apparently may also include hardware needed by other services. The processor 1702 reads a corresponding computer program from the non-volatile memory 1710 into the memory 1708 for running to form an attendance configuration apparatus at a logical level. Apparently, in addition to software implementations, the present disclosure does not exclude other implementations, such as a logic device or a combination of software and hardware, etc., In other words, an execution body of the following flow of processing is not limited to various logic units, and may also be a hardware or logic device.

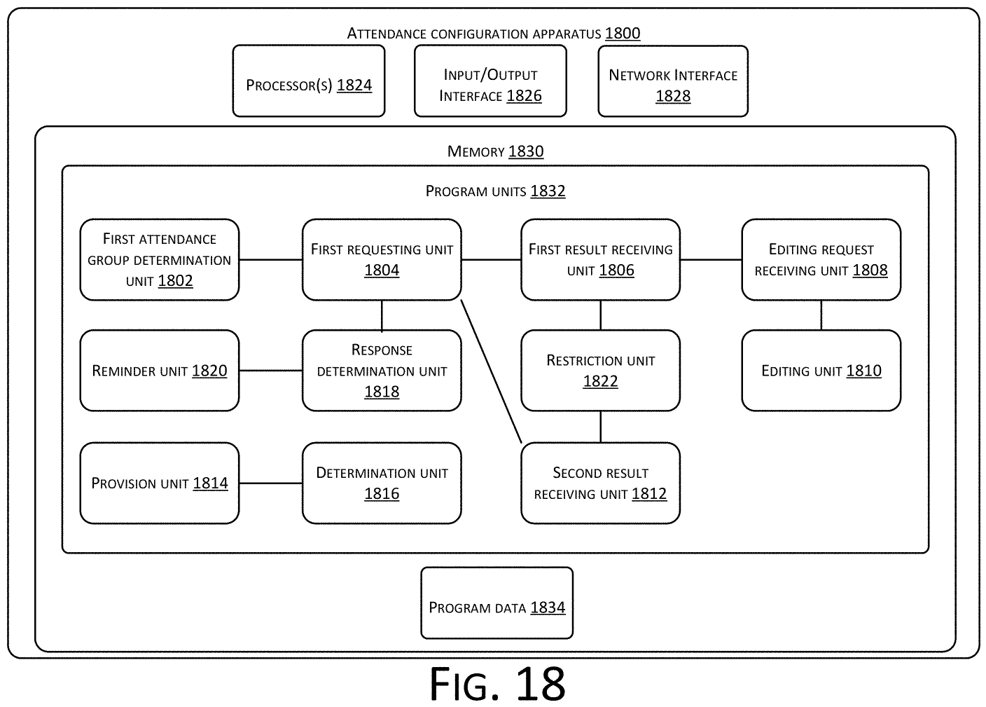

Referring to FIG. 18, in implementations, an attendance configuration apparatus 1800 may include:

a first attendance group determination unit 1802 that determines an attendance group related to a community, the attendance group including at least one community member of the community; and

a first requesting unit 1804 that initiates an attendance group configuration request to a person in charge of the attendance group to set an attendance condition of the attendance group by the person in charge.

In implementations, the first attendance group determination unit 1802 is specifically configured to:

determine attendance groups that are obtained by dividing community members of the community by a management member.

In implementations, the first attendance group determination unit 1802 is specifically configured to:

divide respective parts of the community into corresponding attendance groups according to a division of departments defined by organizational structure information of the community, wherein each attendance group includes at least one department within the community.

In implementations, the attendance group configuration request is used to inform the person in charge of the attendance condition to be set, and the apparatus 1800 further includes:

a first result receiving unit 1806 that receives a configuration result returned by the person in charge for the attendance group configuration request, the configuration result including a condition value set by the person in charge for the attendance condition to be set.

In implementations, the apparatus 1800 further includes:

an editing request receiving unit 1808 that receives a condition editing request returned by the person in charge for the attendance condition to be set; and

an editing unit 1810 that edits the attendance condition to be set according to the condition editing request.

In implementations, the apparatus 1800 further includes:

a second result receiving unit 1812 that receives a configuration result returned by the person in charge for the attendance group configuration request, the configuration result including the attendance condition and a corresponding condition value set by the person in charge for the attendance group.

In implementations, the apparatus 1800 further includes:

a provision unit 1814 that provides the configuration result returned by the person in charge for the attendance group configuration request to a management member of the community; and

a determination unit 1816 that determines the attendance condition of the attendance group according to an approval status of the configuration result made by the management member.

In implementations, the apparatus 1800 further includes:

a response determination unit 1818 that determines a response situation of the person in charge of the attendance group with respect to the attendance group configuration request; and

a reminder unit 1820 that sends a reminder message for the attendance group configuration request to the person in charge who has not responded.

In implementations, the reminder unit 1820 sends the reminder message for the attendance group configuration request to the person in charge who has not responded in at least one of the following ways:

initiating a call to the person in charge who has not responded, and playing voice content of the reminder message after being connected;

sending the reminder message in a form of a short message to the person in charge who has not responded; or

sending the reminder message in a form of an instant communication message to the person in charge who has not responded.

In implementations, the attendance condition includes at least one of the following:

a time period associated with attendance, a location associated with attendance, or an access point associated with attendance.

In implementations, the apparatus 1800 further includes:

a restriction unit 1822 that restricts the person in charge from continuing to set attendance conditions of the attendance group through the attendance group configuration request when the configuration result returned by the person in charge for the attendance group configuration request is received.

In implementations, the apparatus 1800 may further include one or more processors 1824, an input/output interface 1826, a network interface 1828, and memory 1830.

The memory 1830 may include a form of computer readable media such as a volatile memory, a random access memory (RAM) and/or a non-volatile memory, for example, a read-only memory (ROM) or a flash RAM. The memory 1830 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 1830 may include program units 1832 and program data 1834. The program units 1832 may include one or more units as described in the foregoing description and FIG. 18.

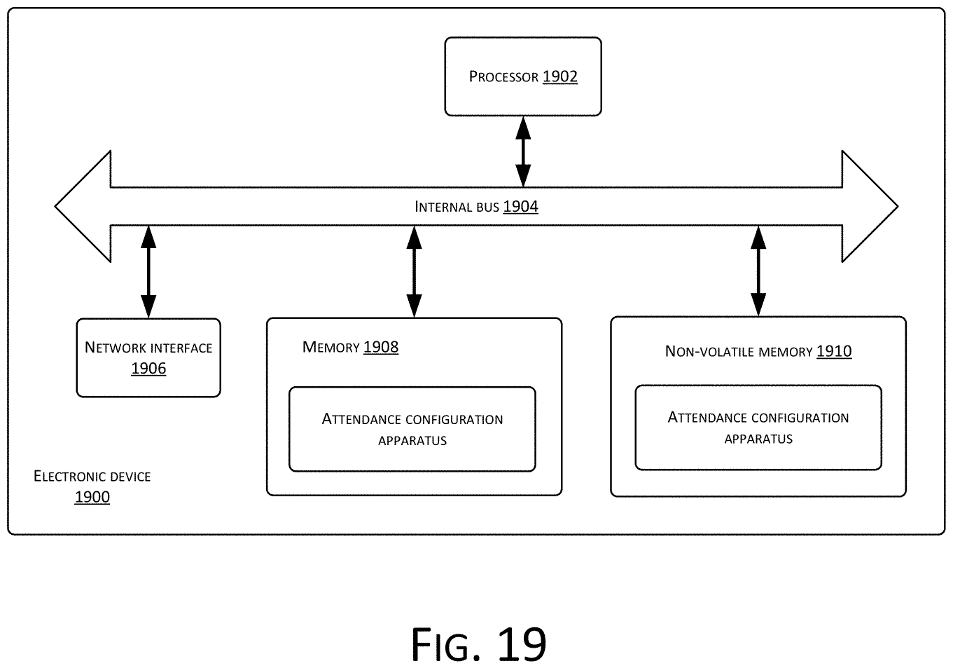

FIG. 19 is a schematic structural diagram of an electronic device 1900 according to an exemplary embodiment. Referring to FIG. 19, at a hardware level, the electronic device 1900 includes a processor 1902, an internal bus 1904, a network interface 1906, a memory 1908, and a non-volatile memory 1910, and apparently may also include hardware needed by other services. The processor 1902 reads a corresponding computer program from the non-volatile memory 1910 into the memory 1908 for running to form an attendance configuration apparatus on a logical level. Apparently, in addition to software implementations, the present disclosure does not exclude other implementations, such as a logic device or a combination of software and hardware, etc. In other words, an execution body of the following flow of processing is not limited to various logic units, and can also be a hardware or logic device.

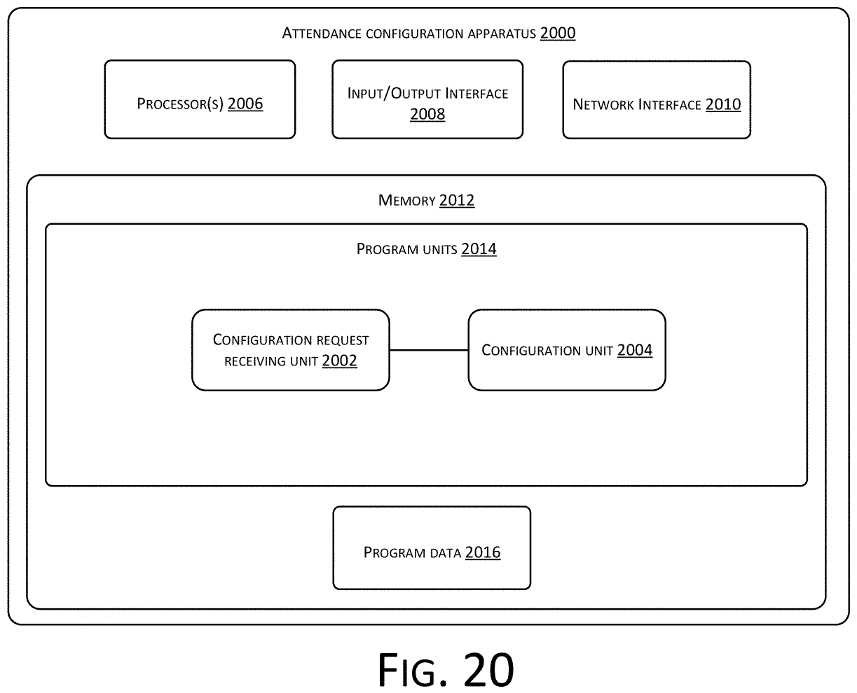

Referring to FIG. 20, in implementations, an attendance configuration apparatus 2000 may include:

a configuration request receiving unit 2002 that receives an attendance group configuration request for an attendance group, a recipient of the attendance group configuration request being a person in charge of the attendance group; and

a configuration unit 2004 that sets attendance condition(s) of the attendance group in response to the attendance group configuration request.

In implementations, the attendance condition(s) include(s) a location associated with attendance, and the configuration unit 2004 is specifically configured to:

display candidate locations in response to the attendance group configuration request being triggered, the candidate locations including at least one of: a location of the recipient, and a relevant location near the recipient; and

set a selected candidate location as the location associated with attendance according to a selection operation of the recipient on the candidate locations.

In implementations, the attendance condition(s) include(s) an access point associated with attendance, and the configuration unit 2004 is specifically configured to:

display candidate access points in response to the attendance group configuration request being triggered, the candidate access points including at least one of the following: an access point detected by an electronic device used by the recipient, access points historically detected by the electronic device; and

set a selected candidate access point as the access point associated with attendance according to a selection operation of the recipient on the candidate access points.

In implementations, the apparatus 2000 may further include one or more processors 2006, an input/output interface 2008, a network interface 2010, and memory 2012.

The memory 2012 may include a form of computer readable media as described in the foregoing description. In implementations, the memory 2012 may include program units 2014 and program data 2016. The program units 2014 may include one or more units as described in the foregoing description and FIG. 20.

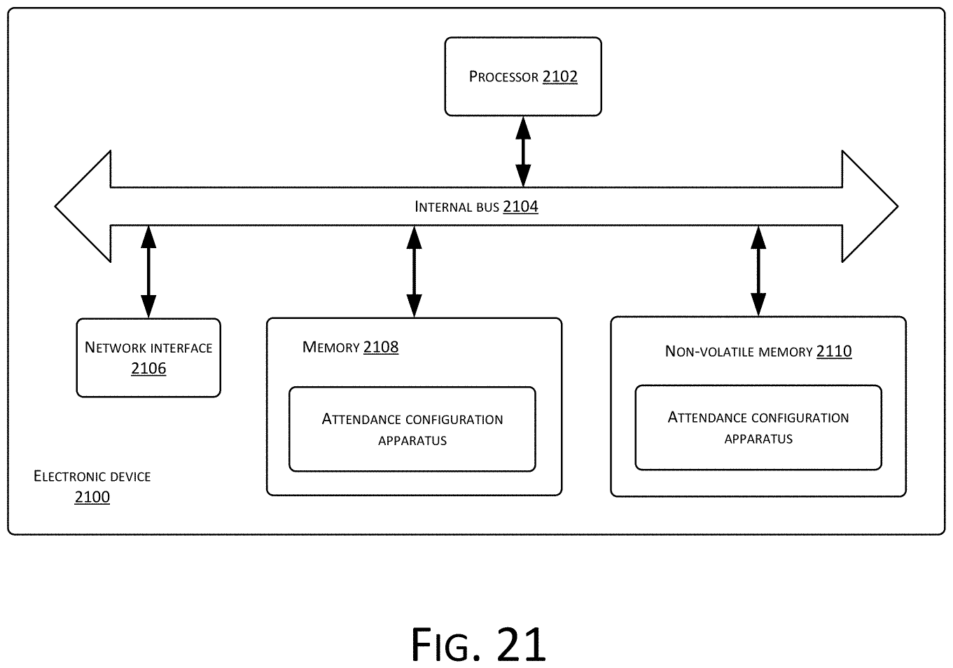

FIG. 21 is a schematic structural diagram of an electronic device 2100 according to an exemplary embodiment. Referring to FIG. 21, at a hardware level, the electronic device 2100 includes a processor 2102, an internal bus 2104, a network interface 2106, a memory 2108, and a non-volatile memory 2110, and apparently may also include hardware needed by other services. The processor 2102 reads a corresponding computer program from the non-volatile memory 2110 into the memory 2108 for running to form an attendance configuration apparatus on a logical level. Apparently, in addition to software implementations, the present disclosure does not exclude other implementations, such as a logic device or a combination of software and hardware, etc. In other words, an execution body of the following flow of processing is not limited to various logic units, and can also be a hardware or logic device.

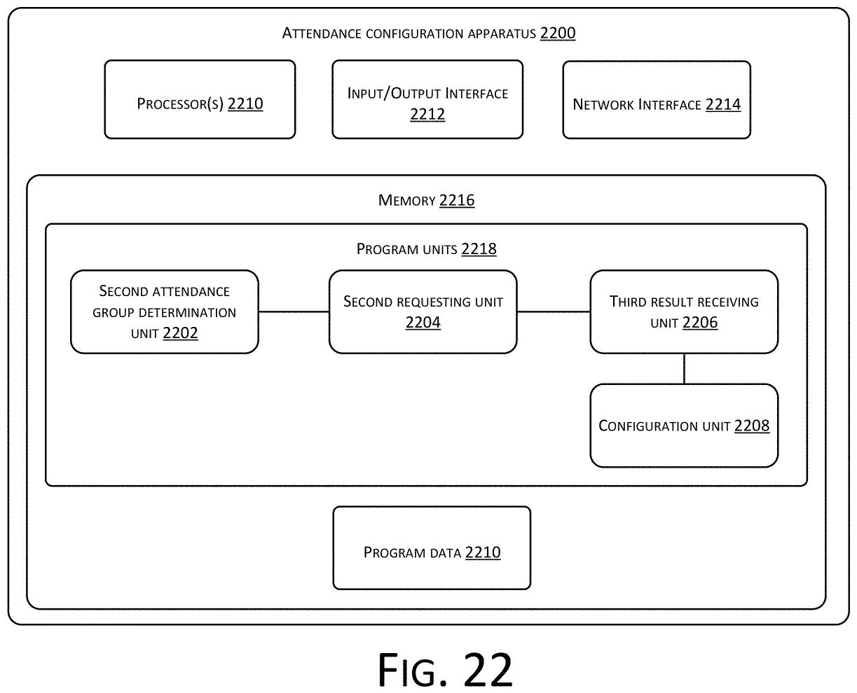

Referring to FIG. 22, in implementations, an attendance configuration apparatus 2200 may include:

a second attendance group determination unit 2202 that determines an attendance group related to a community, the attendance group including at least one community member of the community;

a second requesting unit 2204 that initiates an attendance group configuration request to a person in charge of the attendance group;

a third result receiving unit 2206 that receives a configuration result returned by the person in charge for the attendance group configuration request; and

a configuration unit 2208 that configures an attendance condition of the attendance group according to the configuration result.

In implementations, the configuration unit 2208 is specifically configured to:

implement an examination and approval operation on the configuration result; and

configure the attendance condition of the attendance group according to the configuration result in response to the configuration result being approved.

In implementations, the apparatus 2200 may further include one or more processors 2210, an input/output interface 2212, a network interface 2214, and memory 2216.

The memory 2216 may include a form of computer readable media as described in the foregoing description. In implementations, the memory 2216 may include program units 2218 and program data 2220. The program units 2218 may include one or more units as described in the foregoing description and FIG. 22.

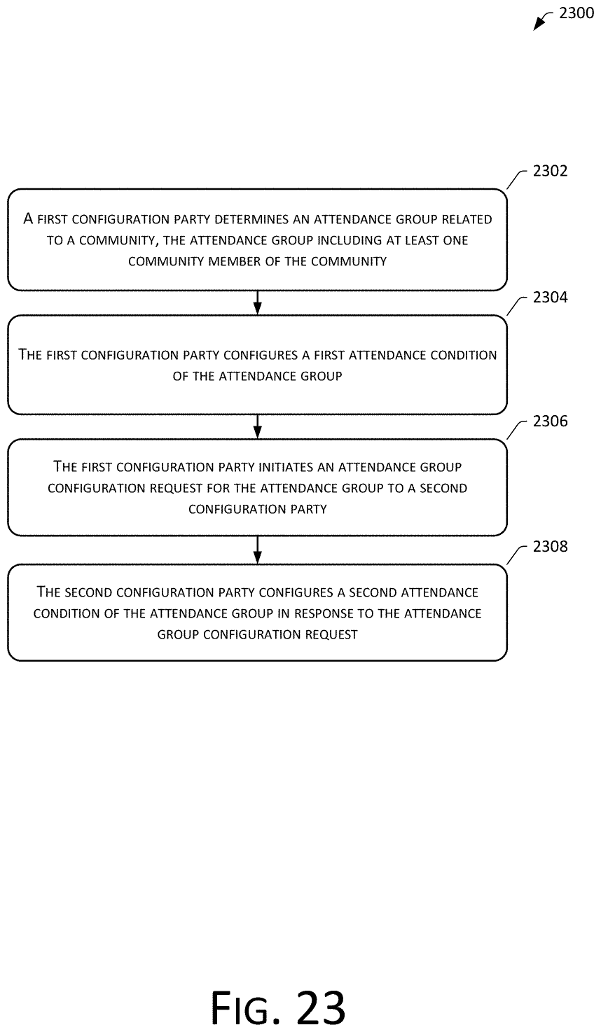

FIG. 23 is a flowchart of another attendance configuration method 2300 according to an exemplary embodiment. As shown in FIG. 23, the method 2300 may include the following steps:

Step 2302: A first configuration party determines an attendance group related to a community, the attendance group including at least one community member of the community.

In implementations, the attendance group may be set in advance by the first configuration party or other personnel before step 2302, and only a division result of attendance groups in advance need be known at step 2302.

In implementations, community members of the community may be divided into corresponding attendance groups by the first configuration party at step 2302.

In implementations, the community members can be divided into the corresponding attendance groups in any manner.

In implementations, departmental divisions can be defined based on organizational structure information of the community, and parts of the community can be divided into corresponding attendance groups respectively. Each attendance group includes at least one department in the community. For example, organizational structure information of a community defines a division of departments within the community, and the community members can be automatically divided into a plurality of attendance groups based on the division of the departments. A preset division rule can include information of a dimension for dividing the attendance groups. For example, when the dimension is “group”, community members of each group can be divided into an attendance group separately. When the dimension is “department”, community members of each department can be divided into an attendance group separately. Apparently, information of any other dimension can be used, or information of multiple dimensions can be used at the same time. The present disclosure does not have any limitations thereon.

Step 2304: The first configuration party configures a first attendance condition of the attendance group.

In implementations, the first configuration party may include a management member of the community, i.e., the first configuration party has a management authority over the community, so that the first configuration party may divide community members in the community into attendance groups, configure a first attendance condition, etc.

Step 2306: The first configuration party initiates an attendance group configuration request for the attendance group to a second configuration party.

Step 2308: The second configuration party configures a second attendance condition of the attendance group in response to the attendance group configuration request.

In implementations, the first configuration party can be a management member of the community, and the second configuration party can be a person in charge of one or more attendance groups, so that the first configuration party and the second configuration party can set attendance conditions of different attendance groups respectively without the need for the first configuration party to set all the attendance conditions, thus helping to improve the configuration efficiency.

In implementations, the first attendance condition may include a time period associated with attendance, and the second attendance condition may include a location associated with attendance, an access point associated with attendance, etc., which are not limited in the present disclosure. When the first configuration party and the second configuration party are located at different locations of the community, the second configuration party sets attendance conditions related to a geographical location, such as the location associated with attendance and the access point associated with attendance, rather than being set by the first configuration party who is located at another geographical location, which not only helps to improve the efficiency of setting attendance conditions (an electronic device used by the second configuration party can be located at or near the location associated with attendance, and can search and access the access point associated with attendance), and can also significantly improve the accuracy of setting the attendance conditions.

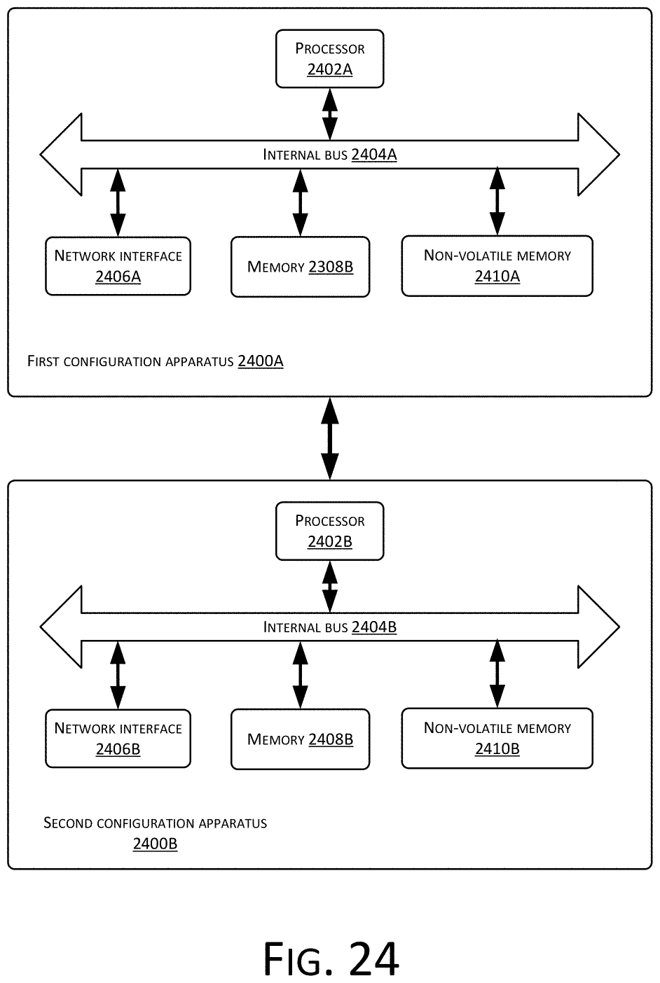

FIG. 24 is a schematic structural diagram of an attendance configuration system according to an exemplary embodiment. Referring to FIG. 24, the attendance configuration system may include a first configuration apparatus 2400A and a second configuration apparatus 2400B.

At a hardware level, the first configuration apparatus 2400A includes a processor 2402A, an internal bus 2404A, a network interface 2406A, a memory 2408A, and a non-volatile memory 2410A, and apparently may also include hardware needed by other services. The processor 2402A reads a corresponding computer program from the non-volatile memory 2410A into the memory 2408A for running to implement a corresponding attendance configuration function on a logical level. Similarly, the second configuration apparatus 2400B includes a processor 2402B, an internal bus 2404B, a network interface 2406B, a memory 2408B, and a non-volatile memory 2410B, and apparently may also include hardware needed by other services. The processor 2402B reads a corresponding computer program from the non-volatile memory 2410B into the memory 2408B for running to implement a corresponding attendance configuration function on a logical level. Apparently, in addition to software implementations, the present disclosure does not exclude other implementations, such as a logic device or a combination of software and hardware, etc. In other words, execution bodies of the following flow of processing are not limited to various logic units, and may also be hardware or logic devices.

Referring to FIG. 24, in implementations, the first configuration apparatus 2400A is configured to enable a first configuration party to determine an attendance group related to a community, the attendance group including at least one community member of the community, enable the first configuration party to set a first time attendance condition of the attendance group, and cause the first configuration party to initiate an attendance group configuration request for the attendance group to the second configuration party. The second configuration apparatus 2400B is configured to enable the second configuration party to set a second attendance condition of the attendance group in response to the attendance group configuration request.

In implementations, the first configuration party includes a management member of the community, and the second configuration party includes a person in charge of the attendance group.

The systems, apparatuses, modules, or units described in the foregoing embodiments may be specifically implemented by a computer chip or entity, or a product with certain functions. A typical implementation of a device is a computer, and a specific form of the computer may be a personal computer, a laptop computer, a cellular phone, a camera phone, a smart phone, a personal digital assistant, a media player, a navigation device, an email sending and receiving device, and a game control, a tablet computer, a wearable device, or a combination of any of these devices.

In a typical configuration, a computer includes one or more processors (CPUs), input/output interfaces, network interfaces, and memory.

The memory may include a form of computer readable media such as a volatile memory, a random access memory (RAM) and/or a non-volatile memory, for example, a read-only memory (ROM) or a flash RAM. The memory is an example of a computer readable media.

The computer readable media may include a volatile or non-volatile type, a removable or non-removable media, which may achieve storage of information using any method or technology. The information may include a computer readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

It should also be noted that terms “including”, “containing” or any other variations thereof are intended to cover a non-exclusive inclusion, so that a process, method, product, or device that includes a series of elements not only includes these elements, but also includes other elements that are not explicitly listed, or elements that are inherent to such process, method, product, or device. Without further limitations, an element defined by a sentence “including a . . . ” do not exclude an existence of other identical elements in a process, method, product or device that includes the element.

Specific embodiments of the present disclosure have been described above. Other embodiments fall within the scope of the appended claims. In some cases, actions or steps recited in the claims may be performed in an order different from those in the embodiments and can still achieve a desired result. In addition, a process depicted in a figure does not necessarily require a particular order or a sequential order as shown to achieve a desired result. In some embodiments, multitasking and parallel processing are also possible or may be advantageous.

Terminologies used in the present disclosure are intended for the purpose of describing particular embodiments only and are not intended to limit the present disclosure. Singular forms such as “a”, “said”, and “the” as used in the present disclosure and the appended claims are also intended to include plural forms unless clearly indicated in the context otherwise. It should also be understood that a term “and/or” as used herein refers to and includes any or all possible combinations of one or more of associated items that are listed.

It should be understood that although the present disclosure may use terms such as “first”, “second”, “third”, etc. to describe various pieces of information, these pieces of information should not be limited to these terms. These terms are only used to distinguish information of the same type from each other. For example, without departing from the scope of the present disclosure, first information may also be referred to as second information, and similarly, the second information may also be referred to as first information. Depending on the context, a word “if” as used herein can be interpreted as “when”, “at the time when”, or “in response to a determination of”.

The above descriptions are merely exemplary embodiments of the present disclosure and are not intended to limit the present disclosure. All modifications, equivalent replacements, improvements, etc., that are made within the spirit and principles of the present disclosure, should be included in the scope of protection of the present disclosure.

The present disclosure can be further understood using the following clauses.

Clause 1: An attendance configuration method comprising: determining an attendance group related to a community, the attendance group including at least one community member of the community; and initiating an attendance group configuration request to a person in charge of the attendance group to set an attendance condition of the attendance group by the person in charge.

Clause 2: The method of Clause 1, wherein determining the attendance group related to the community comprises: determining attendance groups that are obtained by dividing community members of the community by a management member.

Clause 3: The method of Clause 1, wherein determining the attendance group related to the community comprises: dividing respective parts of the community into corresponding attendance groups according to a division of departments defined by organizational structure information of the community, wherein each attendance group includes at least one department within the community.

Clause 4: The method of Clause 1, wherein the attendance group configuration request is used to inform the person in charge of the attendance condition to be set, and the method further comprises: receiving a configuration result returned by the person in charge for the attendance group configuration request, the configuration result including a condition value set by the person in charge for the attendance condition to be set.

Clause 5: The method of Clause 4, further comprising: receiving a condition editing request returned by the person in charge for the attendance condition to be set; and editing the attendance condition to be set according to the condition editing request.

Clause 6: The method of Clause 1, further comprising: receiving a configuration result returned by the person in charge for the attendance group configuration request, the configuration result including the attendance condition and a corresponding condition value set by the person in charge for the attendance group.

Clause 7: The method of Clause 1, further comprising: providing the configuration result returned by the person in charge for the attendance group configuration request to a management member of the community; and determining the attendance condition of the attendance group according to an approval status of the configuration result made by the management member.

Clause 8: The method of Clause 1, further comprising: determining a response situation of the person in charge of the attendance group with respect to the attendance group configuration request; and sending a reminder message for the attendance group configuration request to the person in charge who has not responded.

Clause 9: The method of Clause 8, wherein sending the reminder message for the attendance group configuration request to the person in charge who has not responded is performed in at least one of the following ways: initiating a call to the person in charge who has not responded, and playing voice content of the reminder message after being connected; sending the reminder message in a form of a short message to the person in charge who has not responded; or sending the reminder message in a form of an instant communication message to the person in charge who has not responded.

Clause 10: The method of Clause 1, wherein the attendance condition includes at least one of the following: a time period associated with attendance, a location associated with attendance, or an access point associated with attendance.

Clause 11: The method of Clause 1, further comprising: restricting the person in charge from continuing to set attendance conditions of the attendance group through the attendance group configuration request when the configuration result returned by the person in charge for the attendance group configuration request is received.

Clause 12: An attendance configuration method comprising: receiving an attendance group configuration request for an attendance group, a recipient of the attendance group configuration request being a person in charge of the attendance group; and setting an attendance condition of the attendance group in response to the attendance group configuration request.

Clause 13: The method of Clause 12, wherein the attendance condition comprises a location associated with attendance, and setting the attendance condition of the attendance group comprises: displaying candidate locations in response to the attendance group configuration request being triggered, the candidate locations comprising at least one of: a location of the recipient, and a relevant location near the recipient; and setting a selected candidate location as the location associated with attendance according to a selection operation of the recipient on the candidate locations.

Clause 14: The method of Clause 12, wherein the attendance condition comprises an access point associated with attendance, and setting the attendance condition of the attendance group comprises: displaying candidate access points in response to the attendance group configuration request being triggered, the candidate access points including at least one of the following: an access point detected by an electronic device used by the recipient, access points historically detected by the electronic device; and setting a selected candidate access point as the access point associated with attendance according to a selection operation of the recipient on the candidate access points.

Clause 15: An attendance configuration method comprising: determining an attendance group related to a community, the attendance group including at least one community member of the community; initiating an attendance group configuration request to a person in charge of the attendance group; receiving a configuration result returned by the person in charge for the attendance group configuration request; and configuring an attendance condition of the attendance group according to the configuration result.

Clause 16: The method of Clause 15, wherein configuring the attendance condition of the attendance group according to the configuration result comprises: implementing an examination and approval operation on the configuration result; and configuring the attendance condition of the attendance group according to the configuration result in response to the configuration result being approved.

Clause 17: An attendance configuration apparatus comprising: a first attendance group determination unit that determines an attendance group related to a community, the attendance group including at least one community member of the community; and a first requesting unit that initiates an attendance group configuration request to a person in charge of the attendance group to set an attendance condition of the attendance group by the person in charge.

Clause 18: The apparatus of Clause 17, wherein the first attendance group determination unit is specifically configured to: determine attendance groups that are obtained by dividing community members of the community by a management member.

Clause 19: The apparatus of Clause 17, wherein the first attendance group determination unit is specifically configured to: divide respective parts of the community into corresponding attendance groups according to a division of departments defined by organizational structure information of the community, wherein each attendance group includes at least one department within the community.

Clause 20: The apparatus of Clause 17, wherein the attendance group configuration request is used to inform the person in charge of the attendance condition to be set, and the apparatus further comprises: a first result receiving unit that receives a configuration result returned by the person in charge for the attendance group configuration request, the configuration result including a condition value set by the person in charge for the attendance condition to be set.

Clause 21: The apparatus of Clause 20, further comprising: an editing request receiving unit that receives a condition editing request returned by the person in charge for the attendance condition to be set; and an editing unit that edits the attendance condition to be set according to the condition editing request.

Clause 22: The apparatus of Clause 17, further comprising: a second result receiving unit that receives a configuration result returned by the person in charge for the attendance group configuration request, the configuration result including the attendance condition and a corresponding condition value set by the person in charge for the attendance group.

Clause 23: The apparatus of Clause 17, further comprising: a provision unit that provides the configuration result returned by the person in charge for the attendance group configuration request to a management member of the community; and a determination unit that determines the attendance condition of the attendance group according to an approval status of the configuration result made by the management member.

Clause 24: The apparatus of Clause 17, further comprising: a response determination unit that determines a response situation of the person in charge of the attendance group with respect to the attendance group configuration request; and a reminder unit that sends a reminder message for the attendance group configuration request to the person in charge who has not responded.

Clause 25: The apparatus of Clause 24, wherein the reminder unit sends the reminder message for the attendance group configuration request to the person in charge who has not responded in at least one of the following ways: initiating a call to the person in charge who has not responded, and playing voice content of the reminder message after being connected; sending the reminder message in a form of a short message to the person in charge who has not responded; or sending the reminder message in a form of an instant communication message to the person in charge who has not responded.

Clause 26: The apparatus of Clause 17, wherein the attendance condition comprises at least one of the following: a time period associated with attendance, a location associated with attendance, or an access point associated with attendance.

Clause 27: The apparatus of Clause 17, further comprising: a restriction unit that restricts the person in charge from continuing to set attendance conditions of the attendance group through the attendance group configuration request when the configuration result returned by the person in charge for the attendance group configuration request is received.

Clause 28: An attendance configuration apparatus comprising: a configuration request receiving unit that receives an attendance group configuration request for an attendance group, a recipient of the attendance group configuration request being a person in charge of the attendance group; and a configuration unit that sets an attendance condition of the attendance group in response to the attendance group configuration request.

Clause 29: The apparatus of Clause 28, wherein the attendance condition comprises a location associated with attendance, and the configuration unit is specifically configured to: display candidate locations in response to the attendance group configuration request being triggered, the candidate locations comprising at least one of: a location of the recipient, and a relevant location near the recipient; and set a selected candidate location as the location associated with attendance according to a selection operation of the recipient on the candidate locations.

Clause 30: The apparatus of Clause 28, wherein the attendance condition comprises an access point associated with attendance, and the configuration unit is specifically configured to: display candidate access points in response to the attendance group configuration request being triggered, the candidate access points comprising at least one of the following: an access point detected by an electronic device used by the recipient, access points historically detected by the electronic device; and set a selected candidate access point as the access point associated with attendance according to a selection operation of the recipient on the candidate access points.

Clause 31: An attendance configuration apparatus comprising: a second attendance group determination unit that determines an attendance group related to a community, the attendance group including at least one community member of the community; a second requesting unit that initiates an attendance group configuration request to a person in charge of the attendance group; a third result receiving unit that receives a configuration result returned by the person in charge for the attendance group configuration request; and a configuration unit that configures an attendance condition of the attendance group according to the configuration result.

Clause 32: The apparatus of Clause 31, wherein the configuration unit is specifically configured to: implement an examination and approval operation on the configuration result; and configure the attendance condition of the attendance group according to the configuration result in response to the configuration result being approved.

Clause 33: An attendance configuration method comprising: determining an attendance group related to a community by a first configuration party, the attendance group including at least one community member of the community; configuring a first attendance condition of the attendance group by the first configuration party; initiating an attendance group configuration request for the attendance group to a second configuration party from the first configuration party; and configuring a second attendance condition of the attendance group by the second configuration party in response to the attendance group configuration request.

Clause 34: The method of Clause 33, wherein the first configuration party comprises a management member of the community, and the second configuration party comprises a person in charge of the attendance group.

Clause 35: An attendance configuration apparatus comprising: a first configuration apparatus that enables a first configuration party to determine an attendance group related to a community, the attendance group including at least one community member of the community, enables the first configuration party to set a first time attendance condition of the attendance group, and causes the first configuration party to initiate an attendance group configuration request for the attendance group to the second configuration party; and a second configuration apparatus that enables the second configuration party to set a second attendance condition of the attendance group in response to the attendance group configuration request.

Clause 36: The apparatus of Clause 35, wherein the first configuration party comprises a management member of the community, and the second configuration party comprises a person in charge of the attendance group.

What is claimed is:

1. A method implemented by one or more computing devices, the method comprising:
determining an attendance group related to a community, the attendance group including at least one community member of the community; and
initiating an attendance group configuration request to a person in charge of the attendance group to set an attendance condition of the attendance group by the person in charge.

2. The method of claim 1, wherein determining the attendance group related to the community comprises determining attendance groups that are obtained by dividing community members of the community by a management member.

3. The method of claim 1, wherein determining the attendance group related to the community comprises dividing respective parts of the community into corresponding attendance groups according to a division of departments defined by organizational structure information of the community, wherein each attendance group includes at least one department within the community.

4. The method of claim 1, wherein the attendance group configuration request is used to inform the person in charge of the attendance condition to be set, and the method further comprises receiving a configuration result returned by the person in charge for the attendance group configuration request, the configuration result including a condition value set by the person in charge for the attendance condition to be set.

5. The method of claim 4, further comprising:
receiving a condition editing request returned by the person in charge for the attendance condition to be set; and
editing the attendance condition to be set according to the condition editing request.

6. The method of claim 1, further comprising receiving a configuration result returned by the person in charge for the attendance group configuration request, the configuration result including the attendance condition and a corresponding condition value set by the person in charge for the attendance group.

7. The method of claim 1, further comprising:
providing the configuration result returned by the person in charge for the attendance group configuration request to a management member of the community; and
determining the attendance condition of the attendance group according to an approval status of the configuration result made by the management member.

8. The method of claim 1, further comprising:
determining a response situation of the person in charge of the attendance group with respect to the attendance group configuration request; and
sending a reminder message for the attendance group configuration request to the person in charge who has not responded.

9. The method of claim 8, wherein sending the reminder message for the attendance group configuration request to the person in charge who has not responded comprises at least one of:
initiating a call to the person in charge who has not responded, and playing voice content of the reminder message after being connected;
sending the reminder message in a form of a short message to the person in charge who has not responded; or
sending the reminder message in a form of an instant communication message to the person in charge who has not responded.

10. The method of claim 1, wherein the attendance condition comprises at least one of:
a time period associated with attendance, a location associated with attendance, or an access point associated with attendance.

11. The method of claim 1, further comprising restricting the person in charge from continuing to set attendance conditions of the attendance group through the attendance group configuration request when the configuration result returned by the person in charge for the attendance group configuration request is received.

12. An apparatus comprising:
one or more processors; and
memory storing executable instructions that, when executed by the one or more processors, cause the one or more processors to perform acts comprising:
receiving an attendance group configuration request for an attendance group, a recipient of the attendance group configuration request being a person in charge of the attendance group; and
setting an attendance condition of the attendance group in response to the attendance group configuration request.

13. The apparatus of claim 12, wherein the attendance condition comprises a location associated with attendance, and setting the attendance condition of the attendance group comprises:
displaying candidate locations in response to the attendance group configuration request being triggered, the candidate locations comprising at least one of: a location of the recipient, and a relevant location near the recipient; and
setting a selected candidate location as the location associated with attendance according to a selection operation of the recipient on the candidate locations.

14. The apparatus of claim 12, wherein the attendance condition comprises an access point associated with attendance, and setting the attendance condition of the attendance group comprises:
displaying candidate access points in response to the attendance group configuration request being triggered, the candidate access points including at least one of the following: an access point detected by an electronic device used by the recipient, access points historically detected by the electronic device; and
setting a selected candidate access point as the access point associated with attendance according to a selection operation of the recipient on the candidate access points.

15. One or more computer readable media storing executable instructions that, when executed by one or more processors, cause the one or more processors to perform acts comprising:
determining an attendance group related to a community, the attendance group including at least one community member of the community;
initiating an attendance group configuration request to a person in charge of the attendance group;
receiving a configuration result returned by the person in charge for the attendance group configuration request; and
configuring an attendance condition of the attendance group according to the configuration result.

16. The one or more computer readable media of claim 15, wherein configuring the attendance condition of the attendance group according to the configuration result comprises:
implementing an examination and approval operation on the configuration result; and
configuring the attendance condition of the attendance group according to the configuration result in response to the configuration result being approved.

17. The one or more computer readable media of claim 15, wherein determining the attendance group related to the community comprises dividing respective parts of the community into corresponding attendance groups according to a division of departments defined by organizational structure information of the community, wherein each attendance group includes at least one department within the community.

18. The one or more computer readable media of claim 15, the acts further comprising:
determining a response situation of the person in charge of the attendance group with respect to the attendance group configuration request; and
sending a reminder message for the attendance group configuration request to the person in charge who has not responded.

19. The one or more computer readable media of claim 18, wherein sending the reminder message for the attendance group configuration request to the person in charge who has not responded comprises at least one of:
initiating a call to the person in charge who has not responded, and playing voice content of the reminder message after being connected;
sending the reminder message in a form of a short message to the person in charge who has not responded; or
sending the reminder message in a form of an instant communication message to the person in charge who has not responded.

20. The one or more computer readable media of claim 15, the acts further comprising restricting the person in charge from continuing to set attendance conditions of the attendance group through the attendance group configuration request when the configuration result returned by the person in charge for the attendance group configuration request is received.
